(19) United States
(12) Patent Application Publication
(10) Pub. No.: US 2025/0199846 A1
(43) Pub. Date: Jun. 19, 2025

(54) METHOD AND APPARATUS FOR DATA PROCESSING BASED ON BLOCKCHAIN NETWORK, DEVICE, AND STORAGE MEDIUM

(71) Applicant: Tencent Technology (Shenzhen) Company Limited, Shenzhen (CN)

(72) Inventor: ZHUGUANG SHAO, Shenzhen (CN)

(73) Assignee: Tencent Technology (Shenzhen) Company Limited, Shenzhen (CN)

(21) Appl. No.: 19/067,526

(22) Filed: Feb. 28, 2025

Related U.S. Application Data
(63) Continuation of application No. PCT/CN2023/122263, filed on Sep. 27, 2023.

(30) Foreign Application Priority Data
Jan. 31, 2023 (CN) 202310110529.8

(51) Int. Cl. G06F 9/46; H04L 9/00

(52) U.S. Cl. CPC G06F 9/466; H04L 9/50

(57) ABSTRACT

A method and an apparatus for data processing based on a blockchain network, a device, and a storage medium are provided. The blockchain network includes a leader node, a follower node, and a transaction receiving node. For a follower node side, the method includes: receiving consensus proposal information broadcast by the leader node; obtaining a batch structure of an incomplete consensus batch when it is determined that one of the one or more consensus batches is incomplete in a transaction pool of the follower node; determining, based on the batch structure of the incomplete consensus batch, that a broadcast batch corresponding to the incomplete consensus batch is incomplete; obtaining the incomplete broadcast batch from the leader node, and recovering the transaction that requires consensus and is proposed in the consensus proposal information; and reaching consensus on the recovered transaction that requires consensus.

### RELATED APPLICATION

This application is a continuation of International Patent Application No. PCT/CN2023/122263, filed Sep. 27, 2023, which claims priority to Chinese Patent Application No. 202310110529.8, entitled “METHOD AND APPARATUS FOR CONSENSUS PROCESSING BASED ON BLOCKCHAIN NETWORK, DEVICE, AND STORAGE MEDIUM” and filed with the China National Intellectual Property Administration on Jan. 31, 2023. The above applications are incorporated herein by reference in their entireties.

### TECHNICAL FIELD

This disclosure relates to the field of computer technologies, and in particular, to a method for data processing based on a blockchain network, an apparatus for data processing based on a blockchain network, a computer device, a computer-readable storage medium, and a computer program product.

### BACKGROUND

With rapid development of computer technologies, blockchain technologies become increasingly mature. The blockchain technologies have distinctive advantages in characteristics such as openness, transparency, and trustworthiness, and more services choose to use the blockchain technologies. In the blockchain technologies, a consensus process is usually a process affecting performance of the blockchain technologies. For a consensus process in which a Byzantine fault tolerance (BFT)-type consensus algorithm is used, a leader node usually proposes, to generate consensus proposal information, and broadcasts the consensus proposal information to a follower node for consensus. The consensus proposal information includes a transaction on which consensus is to be reached. In such a consensus process, when a quantity of transactions in a block is substantial, or a transaction is large (which means that the transaction occupies a large space after being serialized), a quantity of transactions that can be accommodated in the consensus proposal information is limited, and a broadcast speed of the consensus proposal information is reduced. Consequently, a clear bottleneck is formed when the consensus proposal information is broadcast, affecting consensus efficiency.

### SUMMARY

Embodiments of the present disclosure provide a method and an apparatus for data processing based on a blockchain network, a device, and a storage medium, to improve consensus efficiency.

According to an aspect, an embodiment of the present disclosure provides a method for data processing based on a blockchain network. The blockchain network includes a leader node, a follower node, and a transaction receiving node. The method for data processing based on a blockchain network is performed by the follower node, and the method for data processing based on a blockchain network includes:
receiving consensus proposal information broadcast by the leader node, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached;
if it is determined, based on a consensus batch identifier in the consensus proposal information, that a consensus batch is incomplete in a transaction pool of the follower node, obtaining a batch structure of the incomplete consensus batch; the transaction pool of the follower node being configured to store a broadcast batch and a consensus batch broadcast by the transaction receiving node; and
determining, based on the batch structure of the incomplete consensus batch, that a broadcast batch corresponding to the incomplete consensus batch is incomplete;
obtaining the incomplete broadcast batch from the leader node, and recovering, based on a transaction on which consensus is to be reached in the incomplete broadcast batch, the transaction that requires consensus and is proposed in the consensus proposal information; and
reaching consensus on the recovered transaction that requires consensus.

Correspondingly, an embodiment of the present disclosure provides an apparatus for data processing based on a blockchain network. The blockchain network includes a leader node, a follower node, and a transaction receiving node. The apparatus for data processing based on a blockchain network is disposed in the follower node, and the apparatus for data processing based on a blockchain network includes:
a communication unit, configured to receive consensus proposal information broadcast by the leader node, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached; and
a processing unit, configured to obtain, if it is determined, based on the consensus batch identifier in the consensus proposal information, that a consensus batch is incomplete in a transaction pool of the follower node, a batch structure of the incomplete consensus batch, the transaction pool of the follower node being configured to store a broadcast batch and a consensus batch broadcast by the transaction receiving node; and
the processing unit being further configured to determine, based on the batch structure of the incomplete consensus batch, that a broadcast batch corresponding to the incomplete consensus batch is incomplete;
the processing unit being further configured to obtain the incomplete broadcast batch from the leader node, and recover, based on a transaction on which consensus is to be reached in the incomplete broadcast batch, the transaction that requires consensus and is proposed in the consensus proposal information; and
the processing unit being further configured to reach consensus on the recovered transaction that requires consensus.

According to another aspect, an embodiment of the present disclosure provides a method for data processing based on a blockchain network. The blockchain network includes a leader node, a follower node, and a transaction receiving node. The method for data processing based on a blockchain network is performed by the leader node, and the method for data processing based on a blockchain network includes:
creating consensus proposal information, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached; and
broadcasting the consensus proposal information to the follower node, to cause the follower node to obtain, if it is determined, based on the consensus batch identifier in the consensus proposal information, that a consensus batch is incomplete in a transaction pool of the follower node, a batch structure of the incomplete consensus batch after receiving the consensus proposal information; and determine, based on the batch structure of the incomplete consensus batch, that a broadcast batch corresponding to the incomplete consensus batch is incomplete, and obtain the incomplete broadcast batch from the leader node, the transaction pool of the follower node being configured to store a broadcast batch and a consensus batch broadcast by the transaction receiving node; and
returning the incomplete broadcast batch to the follower node, to cause the follower node to recover, based on a transaction on which consensus is to be reached in the incomplete broadcast batch, the transaction that requires consensus and is proposed in the consensus proposal information, and reach consensus on the recovered transaction that requires consensus.

Correspondingly, an embodiment of the present disclosure provides an apparatus for data processing based on a blockchain network. The blockchain network includes a leader node, a follower node, and a transaction receiving node. The apparatus for data processing based on a blockchain network is disposed in the leader node, and the apparatus for data processing based on a blockchain network includes:
a processing unit, configured to create consensus proposal information, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached; and
a communication unit, configured to broadcast the consensus proposal information to the follower node, to cause the follower node to obtain, if it is determined, based on the consensus batch identifier in the consensus proposal information, that a consensus batch is incomplete in a transaction pool of the follower node, a batch structure of the incomplete consensus batch after receiving the consensus proposal information, determine, based on the batch structure of the incomplete consensus batch, that a broadcast batch corresponding to the incomplete consensus batch is incomplete, and obtain the incomplete broadcast batch from the leader node, the transaction pool of the follower node being configured to store a broadcast batch and a consensus batch broadcast by the transaction receiving node; and
the communication unit being further configured to return the incomplete broadcast batch to the follower node, to cause the follower node to recover, based on a transaction on which consensus is to be reached in the incomplete broadcast batch, the transaction that requires consensus and is proposed in the consensus proposal information, and reach consensus on the recovered transaction that requires consensus.

According to another aspect, an embodiment of the present disclosure provides a method for data processing based on a blockchain network. The blockchain network includes a leader node, a follower node, and a transaction receiving node. The method for data processing based on a blockchain network is performed by the transaction receiving node, and the method for data processing based on a blockchain network includes:
receiving a transaction on which consensus is to be reached;
when a quantity of received transactions on which consensus is to be reached meets a broadcast batch packaging condition, generating a broadcast batch based on one or more of the received transactions on which consensus is to be reached, and broadcasting the broadcast batch to the leader node and the follower node;
when a quantity of the generated broadcast batches meets a consensus batch packaging condition, generating a consensus batch based on a broadcast batch identifier of one or more of the generated broadcast batches;
broadcasting the consensus batch to the leader node, to cause the leader node to create consensus proposal information based on the consensus batch, and broadcast the consensus proposal information to the follower node, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached;
broadcasting the consensus batch to the follower node, to cause the follower node to obtain, if it is determined, based on the consensus batch identifier in the consensus proposal information, that a consensus batch is incomplete in a transaction pool of the follower node, a batch structure of the incomplete consensus batch after receiving the consensus proposal information, and determine, based on the batch structure of the incomplete consensus batch, that a broadcast batch corresponding to the incomplete consensus batch is incomplete; obtain the incomplete broadcast batch from the leader node, and recover, based on a transaction on which consensus is to be reached in the incomplete broadcast batch, the transaction that requires consensus and is proposed in the consensus proposal information; and reach consensus on the recovered transaction that requires consensus, the transaction pool of the follower node being configured to store a broadcast batch and a consensus batch broadcast by the transaction receiving node.

Correspondingly, an embodiment of the present disclosure provides an apparatus for data processing based on a blockchain network. The blockchain network includes a leader node, a follower node, and a transaction receiving node. The apparatus for data processing based on a blockchain network is disposed in the transaction receiving node, and the apparatus for data processing based on a blockchain network includes:
a communication unit, configured to receive a transaction on which consensus is to be reached; and
a processing unit, configured to generate, when a quantity of received transactions on which consensus is to be reached meets a broadcast batch packaging condition, a broadcast batch based on one or more of the received transactions on which consensus is to be reached, and broadcast the broadcast batch to the leader node and the follower node,
the processing unit being further configured to generate, when a quantity of the generated broadcast batches meets a consensus batch packaging condition, a consensus batch based on a broadcast batch identifier of one or more of the generated broadcast batches;
the processing unit being further configured to broadcast the consensus batch to the leader node, to cause the leader node to create consensus proposal information based on the consensus batch, and broadcast the consensus proposal information to the follower node, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached;
the processing unit being further configured to broadcast the consensus batch to the leader node, to cause the follower node to obtain, if it is determined, based on the consensus batch identifier in the consensus proposal information, that a consensus batch is incomplete in a transaction pool of the follower node, a batch structure of the incomplete consensus batch after receiving the consensus proposal information, and determine, based on the batch structure of the incomplete consensus batch, that a broadcast batch corresponding to the incomplete consensus batch is incomplete; obtain the incomplete broadcast batch from the leader node, and recover, based on a transaction on which consensus is to be reached in the incomplete broadcast batch, the transaction that requires consensus and is proposed in the consensus proposal information; and reach consensus on the recovered transaction that requires consensus, the transaction pool of the follower node being configured to store a broadcast batch and a consensus batch broadcast by the transaction receiving node.

Correspondingly, an embodiment of the present disclosure provides a computer device. The computer device includes:
a processor, configured to implement a computer program; and
a computer-readable storage medium, the computer-readable storage medium having a computer program stored therein, and the computer program being configured to be loaded by a processor to perform the method for data processing based on a blockchain network.

Correspondingly, an embodiment of the present disclosure provides a non-transitory computer-readable storage medium. The computer-readable storage medium has a computer program stored therein, and the computer program is configured to be loaded by a processor to perform the method for data processing based on a blockchain network.

Correspondingly, an embodiment of the present disclosure provides a computer program product or a computer program. The computer program product or the computer program includes computer instructions, and the computer instructions are stored in a computer-readable storage medium. A processor of a computer device reads the computer instructions from the computer-readable storage medium and executes the computer instructions, to cause the computer device to perform the method for data processing based on a blockchain network.

In the embodiments of the present disclosure, consensus proposal information includes one or more consensus batch identifiers instead of consensus batch content. In this way, more transactions that require consensus can be proposed in the consensus proposal information, thereby improving the consensus efficiency. Moreover, if it is determined, based on the consensus batch identifier in the consensus proposal information, that a consensus batch is incomplete in a transaction pool of a follower node, a batch structure of the incomplete consensus batch may be obtained, it is determined, based on a batch structure of the incomplete consensus batch, that a broadcast batch corresponding to the incomplete consensus batch is incomplete, and the incomplete broadcast batch is obtained from the leader node. In other words, if a consensus batch is incomplete in the transaction pool of the follower node, an incomplete broadcast batch corresponding to the incomplete consensus batch is obtained from the leader node instead of each broadcast batch corresponding to the incomplete consensus batch. In this way, a data volume obtained from the leader node can be reduced, thereby further improving the consensus efficiency.

### BRIEF DESCRIPTION OF THE DRAWINGS

So that the manner in which the recited features of the present disclosure may be understood in detail, a more particular description of the disclosure may be had by reference to one or more embodiments, some of which are illustrated in the appended drawings. It is to be noted, however, that the appended drawings illustrate only one or more of the several embodiments; therefore, the one or more embodiments provided in the Drawings are not to be considered limiting of the broadest interpretation of the detailed scope. Other effective embodiments as may be described in the Detailed Description may be considered part of the envisioned detailed scope.

FIG. 1 is a schematic architectural diagram of a blockchain network according to an embodiment of the present disclosure.

FIG. 2 is a schematic structural diagram of a blockchain according to an embodiment of the present disclosure.

FIG. 3 is a schematic structural diagram of a process of block generation according to an embodiment of the present disclosure.

FIG. 4 is a schematic flowchart of broadcasting a batch by a transaction receiving node according to an embodiment of the present disclosure.

FIG. 5 is a schematic flowchart of consensus based on a transaction batch according to an embodiment of the present disclosure.

FIG. 6 is a schematic flowchart of a method for data processing based on a blockchain network according to an embodiment of the present disclosure.

FIG. 7 is a schematic diagram of a process of broadcast batch generation according to an embodiment of the present disclosure.

FIG. 8 is a schematic diagram of a process of consensus batch generation according to an embodiment of the present disclosure.

FIG. 9 is a flowchart of batch packaging of a transaction receiving node according to an embodiment of the present disclosure.

FIG. 10 is a schematic flowchart of another method for data processing based on a blockchain network according to an embodiment of the present disclosure.

FIG. 11 is a schematic flowchart of another method for data processing based on a blockchain network according to an embodiment of the present disclosure.

FIG. 12 is a schematic diagram of obtaining a batch structure of an incomplete consensus batch according to an embodiment of the present disclosure.

FIG. 13 is a schematic diagram of obtaining an incomplete broadcast batch according to an embodiment of the present disclosure.

FIG. 14 is a schematic diagram of obtaining a batch structure of a missing transaction batch according to an embodiment of the present disclosure.

FIG. 15 is a schematic flowchart of another method for data processing based on a blockchain network according to an embodiment of the present disclosure.

FIG. 16 is a schematic flowchart of another method for data processing based on a blockchain network according to an embodiment of the present disclosure.

FIG. 17 is a schematic structural diagram of an apparatus for data processing based on a blockchain network according to an embodiment of the present disclosure.

FIG. 18 is a schematic structural diagram of a computer device according to an embodiment of the present disclosure.

To facilitate understanding, identical reference numerals have been used, where possible, to designate identical elements that are common to the figures. It is contemplated that elements and features of one embodiment may be beneficially incorporate in other embodiments without further recitation.

### DETAILED DESCRIPTION

Technical solutions in embodiments of the present disclosure are clearly and completely described in the following with reference to the accompanying drawings. Apparently, the described embodiments are merely some rather than all of embodiments of the present disclosure. All other embodiments obtained by a person of ordinary skill in the art based on embodiments of the present disclosure without making creative efforts shall fall within the protection scope of the present disclosure.

Terms involved in the present disclosure are introduced:

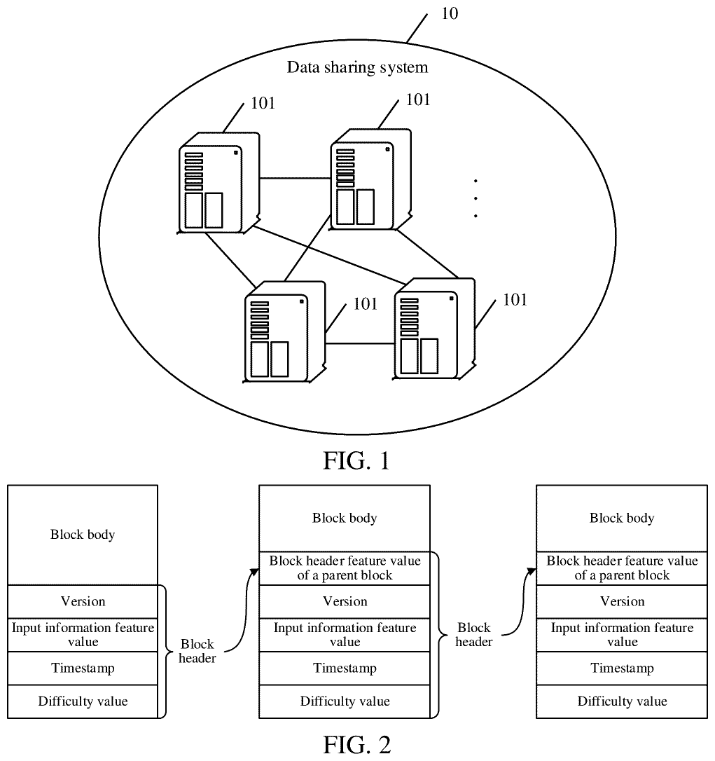

(1) Blockchain network. The blockchain network may be a data sharing system 10 shown in FIG. 1. The data sharing system 10 is a system for sharing data between nodes. The data sharing system may include a plurality of nodes 101, and the plurality of nodes 101 may be clients, terminals, or servers in the data sharing system. Each node 101 may receive input information during ordinary operating condition, and maintain shared data in the data sharing system based on the received input information. To ensure information exchange in the data sharing system, an information connection may exist between the nodes in the data sharing system, and the nodes may transmit information through the information connection. For example, when any node in the data sharing system receives input information, another node in the data sharing system obtains the input information based on a consensus algorithm, and stores the input information as data in the shared data, so that data stored on all nodes in the data sharing system is consistent. Each node in the data sharing system has a corresponding node identifier, and each node in the data sharing system may store a node identifier of the another node in the data sharing system, to subsequently broadcast a generated block to the another node in the data sharing system based on the node identifier of the another node. Each node may maintain a node identifier table shown in Table 1 below, and a node name and a node identifier are correspondingly stored in the node identifier table. The node identifier may be an Internet protocol (IP, a protocol for interconnection between networks) address and any other information that can be configured for identifying the node. The IP address is used only as an example for description in Table 1:

TABLE 1

| Node name | Node identifier |
|---|---|
| Node 1 | XXX.XXX.XXX.XX1 |
| Node 2 | XXX.XXX.XXX.XX2 |
| . . . | . . . |
| Node N | XXX.XXX.XXX.XXN |

(2) Blockchain. Each node in a blockchain network stores a same blockchain. The blockchain includes a plurality of blocks. Refer to a blockchain structure shown in FIG. 2. The blockchain includes a plurality of blocks. A genesis block in the blockchain includes a block header and a block body. The block header of the genesis block stores an input information feature value, a version, a timestamp, and a difficulty value. The block body of the genesis block stores input information (namely, a transaction). A next block of the genesis block uses the genesis block as a parent block. The next block also includes a block header and a block body. The block header stores an input information feature value of the current block, a block header feature value of the parent block, a version, a timestamp, and a difficulty value. Deduced by analogy, block data stored in each block in the blockchain is associated with block data stored in a parent block of the block, thereby ensuring security of input information in the block.

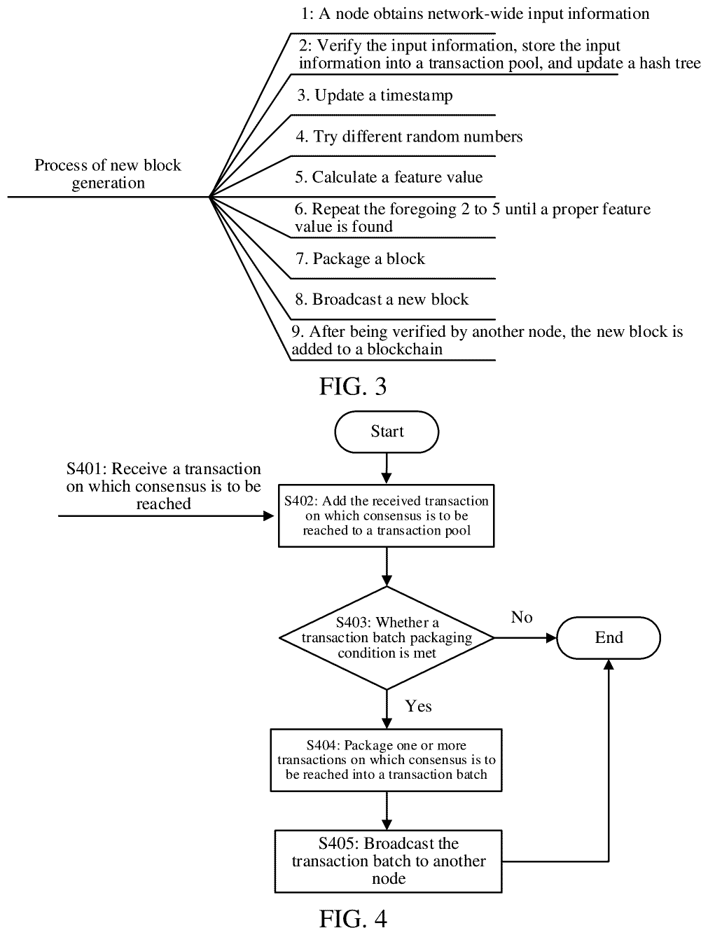

For generation of each block in the blockchain, reference may be made to a process of block generation shown in FIG. 3. When receiving input information, a node on which the blockchain is located verifies the input information. After completing the verification, the node stores the input information into a transaction pool of the node, and updates a hash tree thereof configured for recording the input information. Then, an update timestamp is updated to time when the input information is received, and different random numbers are tried, to perform feature value calculation a plurality of times, so that a calculated feature value can satisfy the following formula:

$$SHA 256 ( SHA 256 ( version + prev\_hash + merkle\_root + ntime + nbits + x ) ) < TARGET$$

A secure hash algorithm 256 (SHA256) is a feature value algorithm configured for calculating a feature value; version is version information of a related block protocol in the blockchain; prev_hash is a block header feature value of a parent block of the current block; merkle_root is a feature value of input information; ntime is update time of an update timestamp; nbits is current difficulty, is a fixed value within a period of time, and is determined again after a fixed period of time; x is a random number; and TARGET is a feature value threshold, and the feature value threshold can be determined based on nbits.

In this way, when a random number satisfying the formula is calculated, the information can be correspondingly stored, and the block header and the block body are generated, to obtain the current block. Subsequently, the node on which the blockchain is located respectively sends, based on a node identifier of another node in a data sharing system, the newly generated block to the another node in the data sharing system. The another node verifies the newly generated block, and adds, after completing the verification, the newly generated block to a blockchain stored therein.

Based on the related descriptions of the foregoing terms, before a block is added to a blockchain, verification requires to be performed. Verification is consensus, which means that consensus is reached on a transaction in the block, and the block is added to the blockchain after the consensus succeeds. A consensus process is usually implemented based on a consensus algorithm. The consensus algorithm may include, but is not limited to: a BFT-type consensus algorithm, a practical Byzantine fault tolerance (PBFT)-type consensus algorithm, a proof of work (PoW)-type consensus algorithm, a proof of stake (POS)-type consensus algorithm, and the like. For example, in embodiments of the present disclosure, a consensus process using a BFT-type consensus algorithm is used as an example for description. The blockchain network may include at least the following three types of nodes: a transaction receiving node, a leader node, and a follower node. A direct or an indirect communication connection may be established between the transaction receiving node, the leader node, and the follower node in a wired communication manner or a wireless communication manner. The transaction receiving node is a node receiving a transaction. The leader node is a node proposing a transaction. The follower node is a node that reaches consensus on the transaction proposed by the leader node. Each node in the blockchain network maintains a respective transaction pool. The transaction pool is a set of transactions on which consensus is to be reached that are in the blockchain network and that have not been packaged into a block. The transaction pool is a temporary storage area, and is configured to store the transactions on which consensus is to be reached.

Based on a blockchain network including a transaction receiving node, a leader node, and a follower node, an embodiment of the present disclosure provides a method for data processing based on a blockchain network. The method for data processing based on a blockchain network may include a transaction broadcast stage and a transaction consensus stage. The transaction broadcast stage is a stage at which a transaction is propagated to nodes in the blockchain network. The transaction consensus stage is a stage at which consensus is reached on a transaction. For details of the method for data processing based on a blockchain network, reference may be made to the following content:

At the transaction broadcast stage, for the transaction receiving node, as shown in FIG. 4, a processing procedure performed by the transaction receiving node includes the following operations. S401: Receive a transaction on which consensus is to be reached. S402: Add the received transaction on which consensus is to be reached to a transaction pool of the transaction receiving node. S403: Determine whether a quantity of transactions on which consensus is to be reached in the transaction pool of the transaction receiving node meets a transaction batch packaging condition. For example, that the quantity of transactions on which consensus is to be reached in the transaction pool of the transaction receiving node meets the transaction batch packaging condition may be: the quantity of transactions on which consensus is to be reached in the transaction pool of the transaction receiving node is greater than or equal to a first quantity threshold. The first quantity threshold may be a preset value. For example, the first quantity threshold may be 3, 5, or 7. This is not limited in the embodiments of the present disclosure. If a determining result is no, in other words, when the quantity of transactions on which consensus is to be reached in the transaction pool of the transaction receiving node does not meet the transaction batch packaging condition, the processing procedure ends. If a determining result is yes, in other words, when the quantity of transactions on which consensus is to be reached in the transaction pool of the transaction receiving node meets the transaction batch packaging condition, S404 is performed. One or more of the transactions on which consensus is to be reached in the transaction pool of the transaction receiving node may be packaged into a transaction batch. In other words, the transaction batch may be understood as a transaction set including one or more of the transactions on which consensus is to be reached. S405: The transaction receiving node may broadcast the transaction batch to other nodes (including the leader node and follower node) in the blockchain network other than the transaction receiving node.

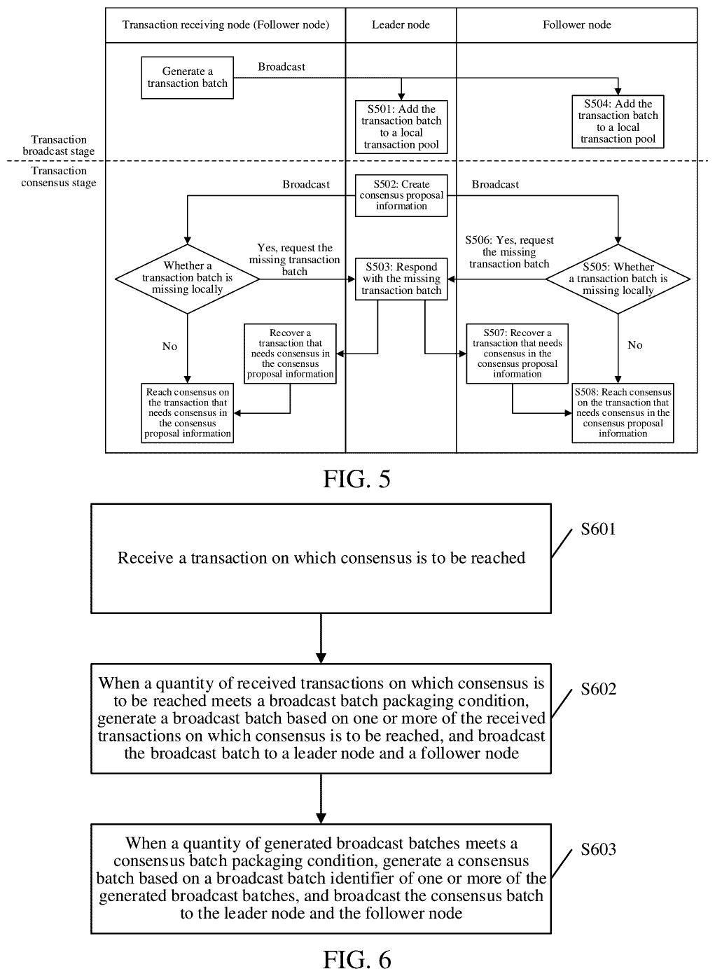

At the transaction consensus stage, for the leader node, as shown in FIG. 5, a processing procedure performed by the leader node includes the following operations. S501: After receiving the transaction batch broadcast by the transaction receiving node, add the received transaction batch to a transaction pool of the leader node. S502: The leader node may create consensus proposal information based on a transaction batch identifier (transaction batch ID) of one or more transaction batches in the transaction pool of the leader node, where the consensus proposal information may be configured for proposing a transaction that requires consensus. In this embodiment, the consensus proposal information includes one or more transaction batch identifiers, and each transaction batch identifier is configured to distinctively identify a corresponding transaction batch. In this case, the transaction that requires consensus and is proposed in the consensus proposal information is: a transaction in a transaction batch corresponding to the transaction batch identifier in the consensus proposal information. The leader node may broadcast the consensus proposal information to the follower node for consensus. The transaction receiving node may participate in the consensus as a follower node. In addition, the leader node may further perform S503, to respond to the follower node with a missing transaction batch that the follower node requests to obtain. The missing transaction batch means: at the transaction consensus stage, if a transaction batch corresponding to the transaction batch identifier in the consensus proposal information is not stored in the transaction pool, the transaction batch is a missing transaction batch. For example, the consensus proposal information includes a transaction batch identifier ID-a, and the transaction batch identifier ID-a corresponds to a transaction batch A. When the follower node reaches consensus on the consensus proposal information, the follower node finds that the transaction batch A does not exist in a transaction pool of the follower node. In this case, the transaction batch A is a missing transaction batch of the follower node.

At the transaction consensus stage, for the follower node, as shown in FIG. 5, a processing procedure performed by the follower node includes the following operations. S504: After receiving a transaction batch broadcast by the transaction receiving node, add the received transaction batch to the transaction pool of the follower node. S505: After receiving the consensus proposal information broadcast by the leader node, based on the transaction batch identifier in the consensus proposal information, the follower node may check, for the transaction batch proposed in the consensus proposal information, whether a transaction batch is missing in the transaction pool of the follower node. If a check result is yes, in other words, when a transaction batch is missing in the transaction pool of the follower node, S506 is performed, to request obtaining the missing transaction batch from the leader node. S507: The follower node may recover, based on the obtained missing transaction batch, the transaction that requires consensus in the consensus proposal information, and perform S508 to reach consensus on the recovered transaction that requires consensus.

In the method for data processing based on a blockchain network, the consensus proposal information stores no longer a transaction but a transaction batch identifier, which compresses content contained in the consensus proposal information, increasing a quantity of transactions that require consensus and that are proposed in a piece of consensus proposal information, so that consensus efficiency is improved. However, while the method for data processing based on a blockchain network improves the consensus efficiency, there are still some factors affecting the consensus efficiency:

(1) When a quantity of transactions that require to be packaged in a transaction batch in the transaction receiving node is large (for example, the quantity of transactions is greater than or equal to a preset quantity threshold), a generation speed of the transaction batch may be slow, and the transaction batch cannot be broadcast to another node in time. Consequently, two problems may be caused: First, the leader node receives the transaction batch at a slow speed. As a result, consensus proposal information cannot be generated in time, and a consensus process cannot be performed in time, affecting the consensus efficiency. Alternatively, a quantity of transaction batch identifiers in a piece of consensus proposal information generated by the leader node is small, and consequently, a quantity of transactions that require consensus and that are proposed in a piece of consensus proposal information is small. As a result, an objective of improving the consensus efficiency cannot be achieved. Second, the follower node does not receive enough transaction batches. Consequently, when the follower node processes consensus proposal information sent by the leader node, because no transaction that requires consensus exists in the transaction pool of the follower node, a procedure of obtaining a transaction from another node by the follower node is triggered. This affects the consensus efficiency.

(2) When a quantity of transactions that require to be packaged in a transaction batch in the transaction receiving node is small (for example, the quantity of transactions is less than a preset quantity threshold), a generation speed of the transaction batch may be fast, a quantity of transaction batches is increased, and a large quantity of transaction batches are broadcast to another node. Consequently, two problems may be caused: First, a large quantity of transaction batch identifiers are included in a piece of consensus proposal information created by the leader node. Consequently, a speed of broadcasting the consensus proposal information is slowed, affecting the consensus efficiency. Second, a probability that a transaction batch is lost in a broadcast process is high, and a procedure of re-obtaining the transaction batch by the follower node is triggered, affecting the consensus efficiency.

Based on this, an embodiment of the present disclosure provides another method for data processing based on a blockchain network. The method for data processing based on a blockchain network may include a transaction broadcast stage and a transaction consensus stage. In addition, the method for data processing based on a blockchain network provides concepts of a broadcast batch and a consensus batch. The broadcast batch may include one or more transactions on which consensus is to be reached. In other words, the broadcast batch may be understood as a transaction set including one or more transactions on which consensus is to be reached. The consensus batch may include one or more broadcast batch identifiers (broadcast batch IDs), and each broadcast batch identifier is configured to distinctively identify a corresponding broadcast batch. In other words, the consensus batch may be understood as a broadcast batch identifier set including one or more broadcast batch identifiers. At the transaction broadcast stage, a transaction receiving node may broadcast the broadcast batch and the consensus batch to other nodes (including a leader node and a follower node). The other nodes may query, based on the broadcast batch identifier in the consensus batch, whether a broadcast batch corresponding to a consensus batch in a respective transaction pool of each node is lost. If a broadcast batch is lost, the lost broadcast batch may be obtained from the transaction receiving node in time. The lost broadcast batch means: at the transaction broadcast stage, a broadcast batch corresponding to each broadcast batch identifier in the consensus batch may be lost in a transmission process because a part of or all of the broadcast batches corresponding to the consensus batch are not successfully transmitted due to a network or the like, and a broadcast batch that is not successfully transmitted is the lost broadcast batch. In an implementation, unsuccessful transmission includes that the entire broadcast batch is not stored in the transaction pool because transmission of the entire broadcast batch fails. For example, the consensus batch transmitted by the transaction receiving node includes a broadcast batch identifier ID-a1, a broadcast batch identifier ID-a2, and a broadcast batch identifier ID-a3. The broadcast batch transmitted by the transaction receiving node includes a broadcast batch a1 corresponding to the broadcast batch identifier ID-a1, a broadcast batch a2 corresponding to the broadcast batch identifier ID-a2, and a broadcast batch a3 corresponding to the broadcast batch identifier ID-a3. However, the leader node (or the follower node) queries a respective transaction pool and finds that the broadcast batch a2 corresponding to the broadcast batch identifier ID-a2 does not exist. In this case, it can be determined that the entire broadcast batch a2 is not stored in the transaction pool of the leader node (or the follower node) because the entire broadcast batch a2 is lost due to unsuccessful transmission. In other words, the broadcast batch a2 is a lost broadcast batch of the leader node (or the follower node). In another implementation, the unsuccessful transmission means that the broadcast batch is not completely stored in the transaction pool because a part of the broadcast batch fails to be transmitted. For example, the consensus batch transmitted by the transaction receiving node includes a broadcast batch identifier ID-a2, and the broadcast batch identifier ID-a2 distinctively identifies a corresponding broadcast batch a2. The broadcast batch a2 includes a transaction a2-1 on which consensus is to be reached and a transaction a2-2 on which consensus is to be reached. However, the leader node (or the follower node) queries a respective transaction pool and finds that the broadcast batch a2 includes only the transaction a2-1 on which consensus is to be reached and does not include the transaction a2-2 on which consensus is to be reached. In this case, it can be determined that the broadcast batch a2 is not completely stored in the transaction pool because the transaction a2-2 on which consensus is to be reached in the broadcast batch a2 fails to be transmitted, and the broadcast batch a2 is a lost broadcast batch.

At the transaction consensus stage, consensus proposal information may include one or more consensus batch identifiers (consensus batch IDs), and each consensus batch identifier is configured to distinctively identify a corresponding consensus batch. After the follower node receives the consensus proposal information broadcast by the leader node, if it is determined, based on the consensus batch identifier in the consensus proposal information, that a consensus batch is incomplete in the transaction pool of the follower node, a batch structure of the incomplete consensus batch may be obtained, it is determined, based on the batch structure of the incomplete consensus batch, that a broadcast batch corresponding to the incomplete consensus batch is incomplete, and the incomplete broadcast batch may be obtained from the leader node.

In this embodiment, the incomplete consensus batch means: at the transaction consensus stage, if a consensus batch corresponding to a consensus batch identifier in the consensus proposal information is not stored or not completely stored in the transaction pool, the consensus batch that is not stored or not completely stored in the transaction pool is the incomplete consensus batch. For example, the consensus proposal information includes a consensus batch identifier ID-A, and the consensus batch identifier ID-A distinctively identifies a corresponding consensus batch A. When reaching consensus on the consensus proposal information, the follower node finds that the consensus batch A does not exist in the transaction pool of the follower node. In other words, the consensus batch A is not stored in the transaction pool of the follower node. In this case, the consensus batch A is an incomplete consensus batch of the follower node. For another example, the consensus proposal information includes a consensus batch identifier ID-A, the consensus batch identifier ID-A distinctively identifies a corresponding consensus batch A. The consensus batch A includes a broadcast batch identifier ID-a1 and a broadcast batch identifier ID-a2. When reaching consensus on the consensus proposal information, the follower node finds that only a broadcast batch a1 corresponding to the broadcast batch identifier ID-a1 exists in the transaction pool of the follower node, but a broadcast batch a2 corresponding to the broadcast batch identifier ID-a2 does not exist in the transaction pool of the follower node. In this case, a broadcast batch in the consensus batch A is not completely stored in the transaction pool of the follower node. Therefore, the consensus batch A is an incomplete consensus batch.

The incomplete broadcast batch means: at the transaction consensus stage, if a broadcast batch corresponding to a broadcast batch identifier in the incomplete consensus batch is not stored or not completely stored in the transaction pool, the broadcast batch that is not stored or not completely stored in the transaction pool is the incomplete broadcast batch. For example, an incomplete consensus batch A includes a broadcast batch identifier ID-a1 and a broadcast batch identifier ID-a2. When reaching consensus on the consensus proposal information, the follower node finds that only a broadcast batch a1 corresponding to the broadcast batch identifier ID-a1 exists in the transaction pool of the follower node, but a broadcast batch a2 corresponding to the broadcast batch identifier ID-a2 does not exist in the transaction pool of the follower node. In other words, the broadcast batch a2 is not stored in the transaction pool of the follower node. In this case, the broadcast batch a2 is an incomplete broadcast batch of the follower node. For another example, an incomplete consensus batch A includes a broadcast batch identifier ID-a2. The broadcast batch identifier ID-a2 distinctively identifies a corresponding broadcast batch a2. The broadcast batch a2 includes a transaction a2-1 on which consensus is to be reached and a transaction a2-2 on which consensus is to be reached. When reaching consensus on the consensus proposal information, the follower node finds that only the transaction a2-1 on which consensus is to be reached in the broadcast batch a2 exists in the transaction pool of the follower node, and the transaction a2-2 on which consensus is to be reached in the broadcast batch a2 does not exist in the transaction pool of the follower node. In other words, the broadcast batch a2 is not completely stored in the transaction pool of the follower node. In this case, the broadcast batch a2 is an incomplete broadcast batch of the follower node.

Based on the foregoing another method for data processing based on a blockchain network, the consensus proposal information includes the consensus batch identifier rather than consensus batch content or the broadcast batch identifier. In this way, more transactions that require consensus can be proposed in the consensus proposal information, thereby improving the consensus efficiency. Moreover, at the transaction broadcast stage, the follower node may obtain a lost broadcast batch from the transaction receiving node in time based on the broadcast batch identifier in the consensus batch. In this way, frequency of obtaining the lost broadcast batch from another node by the follower node at the transaction consensus stage can be reduced, thereby further improving the consensus efficiency. In addition, if a consensus batch is incomplete in the follower node, an incomplete broadcast batch corresponding to the incomplete consensus batch is obtained from the leader node instead of all broadcast batches corresponding to the incomplete consensus batch. In this way, a data volume obtained from the leader node can be reduced, thereby further improving the consensus efficiency.

Any one of the transaction receiving node, the leader node, or the follower node mentioned in the embodiments of the present disclosure may be a terminal or a server. The terminal described in the embodiments of the present disclosure may be any one of a smartphone, a tablet computer, a notebook computer, a desktop computer, a smart speaker, a smartwatch, an in-vehicle terminal, a smart appliance, or the like, but is not limited thereto. The server mentioned in the embodiments of the present disclosure may be an independent physical server, or may be a server cluster or a distributed system including a plurality of physical servers, or may be a cloud server providing basic cloud computing services such as a cloud service, a cloud database, cloud computing, a cloud function, cloud storage, a network service, cloud communication, a middleware service, a domain name service, a security service, a content delivery network (CDN), and big data and artificial intelligence platforms.

Detailed processes of another method for data processing based on a blockchain network are described below with reference to the accompanying drawings from respective perspectives of a transaction receiving node, a leader node, and a follower node separately. In addition, from a perspective of interaction of the transaction receiving node, the leader node, and the follower node, a detailed process of the method for data processing based on a blockchain network is described. The method for data processing based on a blockchain network mentioned in this embodiment of the present disclosure may include a transaction broadcast stage and a transaction consensus stage.

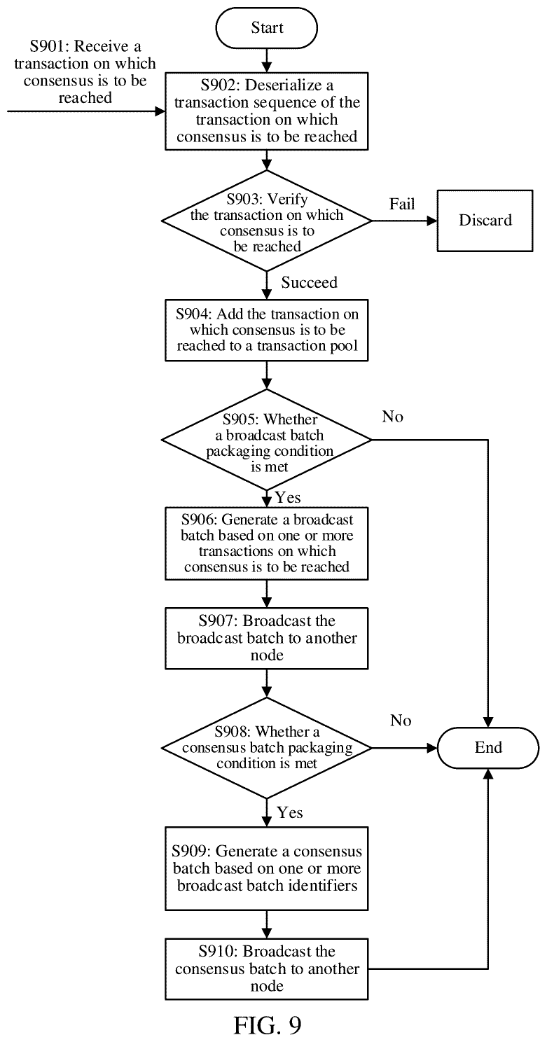

An embodiment of the present disclosure provides a method for data processing based on a blockchain network. The method for data processing based on a blockchain network includes a procedure in which a transaction receiving node packages a broadcast batch and a consensus batch. The procedure may be summarized as a flowchart shown in FIG. 9. The method for data processing based on a blockchain network may be performed by a transaction receiving node in a blockchain network. As shown in FIG. 6, the method for data processing based on a blockchain network may include at least the following operation S601 to operation S603.

S601: Receive a transaction on which consensus is to be reached.

The transaction on which consensus is to be reached is a transaction that requires consensus. The transaction on which consensus is to be reached may be transmitted in a form of a sequence. To be specific, a transaction transmitter of the transaction on which consensus is to be reached may serialize the transaction on which consensus is to be reached, to obtain a transaction sequence of the transaction on which consensus is to be reached, and transmit the transaction sequence of the transaction on which consensus is to be reached to the transaction receiving node. For example, the transaction sequence may be a byte sequence, formed by binary characters. As shown in FIG. 9, after S901 in which the transaction receiving node receives the transaction sequence of the transaction on which consensus is to be reached, S902 in which the transaction sequence of the transaction on which consensus is to be reached is deserialized is performed, to recover the transaction on which consensus is to be reached. Serialization is a process of converting the transaction on which consensus is to be reached into a byte sequence that can be transmitted, and deserialization is a process of recovering the transaction on which consensus is to be reached based on the byte sequence. Through the serialization and the deserialization, it can be ensured that the transaction on which consensus is to be reached can be normally transmitted between the transaction transmitter and the transaction receiving node. In an implementation, data transmission may be performed between the transaction transmitter and the transaction receiving node in a remote procedure call (RPC) protocol manner.

In an implementation, as shown in FIG. 9, in S903, the transaction receiving node may further perform validity verification on the transaction on which consensus is to be reached. If the validity verification performed on the transaction on which consensus is to be reached succeeds, S904 in which the transaction on which consensus is to be reached is added to a transaction pool of the transaction receiving node may be performed. The transaction pool of the transaction receiving node may be configured to store the transaction on which consensus is to be reached received by the transaction receiving node. If the validity verification performed on the transaction on which consensus is to be reached fails, the transaction on which consensus is to be reached may be discarded. The validity verification performed on the transaction on which consensus is to be reached can ensure that all transactions on which consensus is reached are valid transactions, to improve security of a consensus process.

The validity verification performed on the transaction on which consensus is to be reached may include at least one of the following: verify an identity of the transaction transmitter of the transaction on which consensus is to be reached, to verify whether the transmitter of the transaction on which consensus is to be reached is a trusted transaction transmitter; verify authenticity of the transaction on which consensus is to be reached, to verify whether the transaction on which consensus is to be reached is tampered in a transmission process; or the like. That the validity verification performed on the transaction on which consensus is to be reached succeeds includes at least one of the following: the transmitter of the transaction on which consensus is to be reached is a trusted transaction transmitter; or the transaction on which consensus is to be reached is not tampered in the transmission process. That the validity verification performed on the transaction on which consensus is to be reached fails includes any one of the following: the transmitter of the transaction on which consensus is to be reached is not a trusted transaction transmitter, or the transaction on which consensus is to be reached is tampered in the transmission process. If the validity verification performed on the transaction on which consensus is to be reached succeeds, it is determined that the transaction on which consensus is to be reached is a valid transaction. If the validity verification performed on the transaction on which consensus is to be reached fails, it is determined that the transaction on which consensus is to be reached is not a valid transaction.

S602: When a quantity of received transactions on which consensus is to be reached meets a broadcast batch packaging condition, generate a broadcast batch based on one or more of the received transactions on which consensus is to be reached, and broadcast the broadcast batch to a leader node and a follower node.

As shown in FIG. 9, in S905, the transaction receiving node determines whether the quantity of the transactions on which consensus is to be reached received in the transaction pool of the transaction receiving node meets the broadcast batch packaging condition. For example, that the quantity of the transactions on which consensus is to be reached received in the transaction pool of the transaction receiving node meets the broadcast batch packaging condition may be: the quantity of the transactions on which consensus is to be reached received in the transaction pool of the transaction receiving node is greater than or equal to a second quantity threshold. The second quantity threshold may be a preset value. For example, the second quantity threshold may be 4, 5, or 10. This is not limited in the embodiments of the present disclosure. If a determining result is yes, in other words, when the quantity of the transactions on which consensus is to be reached received in the transaction pool of the transaction receiving node meets the broadcast batch packaging condition, S906 in which the broadcast batch is generated based on the one or more of the received transactions on which consensus is to be reached may be performed, and S907 in which the broadcast batch is broadcast to the leader node and the follower node in the blockchain network may be performed.

A batch structure of a broadcast batch may include a broadcast batch identifier (a broadcast batch ID) and broadcast batch content. The broadcast batch content may include one or more transactions on which consensus is to be reached, and the broadcast batch identifier may be generated based on the broadcast batch content (including the one or more transactions on which consensus is to be reached). For a process in which the broadcast batch is generated based on the one or more of the received transactions on which consensus is to be reached, reference may be made to the following descriptions. The quantity of the transactions on which consensus is to be reached for generating the broadcast batch may be a quantity indicated by the second quantity threshold, and multi-layer hash calculation may be performed on the one or more of the transactions on which consensus is to be reached, to obtain a broadcast batch identifier. The one or more of the transactions on which consensus is to be reached may be added to broadcast batch content, and the broadcast batch identifier and the broadcast batch content jointly form the broadcast batch. The multi-layer hash calculation means that first-layer hash information is obtained by performing hash calculation on the one or more of the transactions on which consensus is to be reached, second-layer hash information is obtained by performing hash calculation on the first-layer hash information, and deduced by analogy, last-layer hash information is used as the broadcast batch identifier.

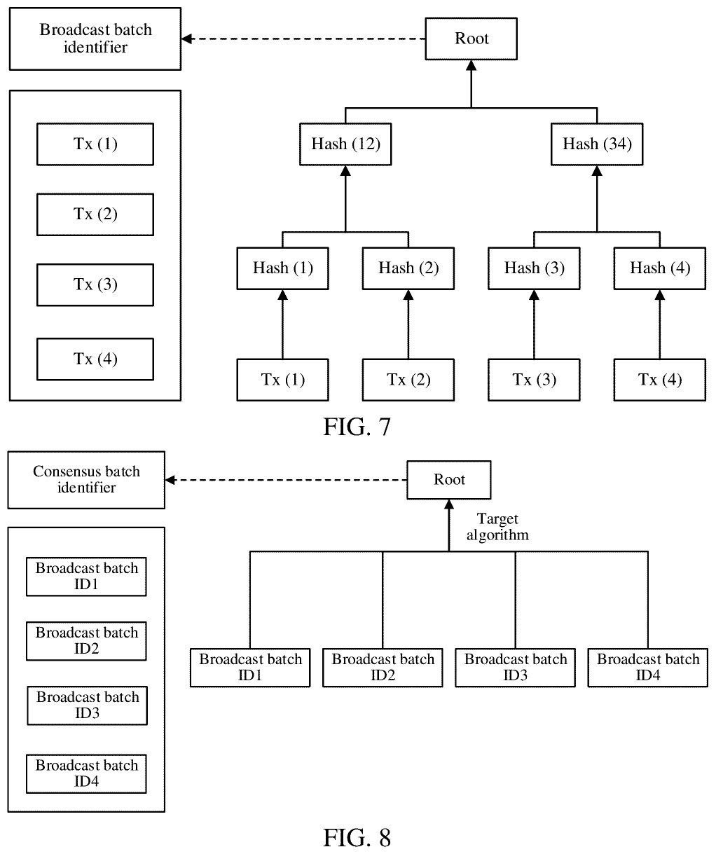

As shown in FIG. 7, when the quantity of the transactions on which consensus is to be reached received in the transaction pool of the transaction receiving node is greater than or equal to the second quantity threshold (which may be, for example, 4), four transactions on which consensus is to be reached may be read in a sequence of transaction receiving time and packaged into a broadcast batch. Specifically, hash calculation may be performed on a transaction 1 (Tx (1)) on which consensus is to be reached, to obtain hash information (Hash (1)) of the transaction 1 on which consensus is to be reached. Similarly, hash information (Hash (2)) of a transaction 2 (Tx (2)) on which consensus is to be reached, hash information (Hash (3)) of a transaction 3 (Tx (3)) on which consensus is to be reached, and hash information (Hash (4)) of a transaction 4 (Tx (4)) on which consensus is to be reached may be obtained. The pieces of hash information may be used as first-layer hash information. After the hash information (Hash (1)) of the transaction 1 on which consensus is to be reached and the hash information (Hash (2)) of the transaction 2 on which consensus is to be reached are concatenated, hash calculation may be performed, to obtain combined hash information 1 (Hash (12)). After the hash information (Hash (3)) of the transaction 3 on which consensus is to be reached and the hash information (Hash (4)) of the transaction 4 on which consensus is to be reached are concatenated, hash calculation may be performed, to obtain combined hash information 2 (Hash (34)). The pieces of combined hash information may be used as second-layer hash information. After the combined hash information 1 (Hash (12)) and the combined hash information 2 (Hash (34)) are concatenated, hash calculation may be performed, to obtain last-layer hash information (Root). The Root may be used as a broadcast batch identifier.

In addition, when the quantity of the transactions on which consensus is to be reached packaged in the broadcast batch is 1, the broadcast batch identifier may be obtained after hash calculation is performed on the one transaction on which consensus is to be reached. Alternatively, when the quantity of the transactions on which consensus is to be reached packaged in the broadcast batch is 1, a transaction identifier of the transaction on which consensus is to be reached may be used as the broadcast batch identifier. A naming rule of the transaction identifier is different from a naming rule of the broadcast batch identifier. Whether the broadcast batch identifier is the transaction identifier may be determined according to the naming rule.

S603: When a quantity of generated broadcast batches meets a consensus batch packaging condition, generate a consensus batch based on a broadcast batch identifier of one or more of the generated broadcast batches, and broadcast the consensus batch to the leader node and the follower node.

As shown in FIG. 9, in S908, the transaction receiving node determines whether the quantity of the generated broadcast batches meets the consensus batch packaging condition. For example, that the quantity of the broadcast batches generated by the transaction receiving node meets the consensus batch packaging condition may be: the quantity of the broadcast batches generated by the transaction receiving nodes is greater than or equal to a third quantity threshold. The third quantity threshold may be a preset value. For example, the third quantity threshold may be 5 or 10. This is not limited in the embodiments of the present disclosure. If a determining result is yes, in other words, when the quantity of the broadcast batches generated by the transaction receiving node meets the consensus batch packaging condition, S909 in which the consensus batch is generated based on the broadcast batch identifier of the one or more of the generated broadcast batches may be performed, and S910 in which the consensus batch is broadcast to the leader node and the follower node may be performed.

A batch structure of the consensus batch may include a consensus batch identifier (a consensus batch ID) and consensus batch content. The consensus batch content may include one or more broadcast batch identifiers (broadcast batch IDs), and the consensus batch identifier may be generated based on the consensus batch content (including the one or more broadcast batch identifiers). For a process in which the consensus batch is generated based on the one or more broadcast batch identifiers, reference may be made to the following descriptions. The quantity of the broadcast batch identifiers for generating the consensus batch may be a quantity indicated by the third quantity threshold. As shown in FIG. 8, when the quantity of the generated broadcast batches is greater than or equal to the third quantity threshold (which may be, for example, 4), broadcast batch identifiers of four broadcast batches may be read in a sequence of broadcast batch generation time and packaged into a consensus batch. Specifically, calculation may be performed on a broadcast batch ID1, a broadcast batch ID2, a broadcast batch ID3, and a broadcast batch ID4 based on a target algorithm, to obtain a consensus batch identifier. The broadcast batch ID1, the broadcast batch ID2, the broadcast batch ID3, and the broadcast batch ID4 may be added to consensus batch content, and the consensus batch identifier and the consensus batch content jointly form the consensus batch. A specific algorithm of the target algorithm is not limited in the embodiments of the present disclosure. For example, the target algorithm may be a hash algorithm.

In addition, the broadcast batch may be lost in a transmission process. After the transaction receiving node broadcasts the consensus batch to the leader node (or the follower node), the leader node (or the follower node) may determine whether a lost broadcast batch corresponding to the broadcast consensus batch is in the leader node (or the follower node). If a broadcast batch is lost in the broadcast consensus batch in the leader node (or the follower node), the leader node (or the follower node) may obtain the lost broadcast batch from the transaction receiving node. In other words, the leader node may obtain the lost broadcast batch from the transaction receiving node in time based on the broadcast batch identifier in the consensus batch at the transaction broadcast stage. In this way, a proposal speed can be increased, and the consensus efficiency can be improved. The follower node may also obtain the lost broadcast batch from the transaction receiving node in time based on the broadcast batch identifier in the consensus batch at the transaction broadcast stage. In this way, frequency of obtaining the lost broadcast batch from another node by the follower node at the transaction consensus stage can be reduced, and the consensus efficiency can be further improved.

In the embodiments of the present disclosure, the transaction on which consensus is to be reached is packaged and broadcast in a form of a batch with a small data volume such as the broadcast batch. In this way, utilization of the blockchain network and transaction receiving performance can be improved, and efficiency can be prevented from being affected due to retransmission caused by an abnormal transmission process when the transaction on which consensus is to be reached is packaged and broadcast in a form of a batch with a large data volume. In addition, after receiving the consensus batch broadcast by the transaction receiving node, the leader node (or the follower node) may check and fill in a gap in the broadcast batch corresponding to the broadcast consensus batch in time. If a broadcast batch is lost, the lost broadcast batch is obtained from the transaction receiving node in time. This can reduce a probability that an obtaining procedure occurs at the transaction consensus stage, to improve the consensus efficiency.

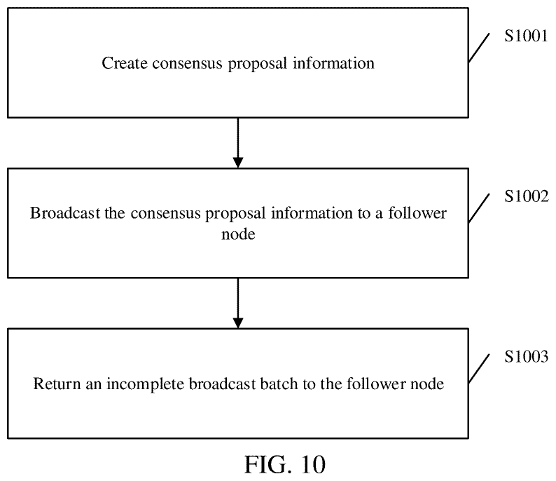

An embodiment of the present disclosure provides a method for data processing based on a blockchain network. The method for data processing based on a blockchain network includes a procedure in which a leader node creates and broadcasts consensus proposal information. The method for data processing based on a blockchain network may be performed by a leader node in a blockchain network. As shown in FIG. 10, the method for data processing based on a blockchain network may include at least the following operation S1001 to operation S1003.

S1001: Create consensus proposal information.

The consensus proposal information may be configured for proposing a transaction that requires consensus. The consensus proposal information may include one or more consensus batch identifiers, and each consensus batch identifier is configured to distinctively identify a corresponding consensus batch. A batch structure of each consensus batch may include one or more broadcast batch identifiers, and each broadcast batch identifier is configured to distinctively identify a corresponding broadcast batch. A batch structure of each broadcast batch may include one or more transactions on which consensus is to be reached.

The consensus proposal information may be generated based on a consensus batch identifier of a received consensus batch broadcast by a transaction receiving node. Specifically, the leader node may receive a broadcast batch broadcast by the transaction receiving node. The received broadcast batch may be generated by the transaction receiving node, when a quantity of received transactions on which consensus is to be reached meets a broadcast batch packaging condition, based on one or more of the received transactions on which consensus is to be reached. The leader node may receive the consensus batch broadcast by the transaction receiving node. The received consensus batch may be generated by the transaction receiving node, when a quantity of generated broadcast batches meets a consensus batch packaging condition, based on a broadcast batch identifier of one or more of the generated broadcast batches. The leader node may perform, based on the received broadcast batch, an integrity check on a broadcast batch corresponding to the received consensus batch. When a quantity of consensus batches that pass the integrity check meets a consensus proposal condition, the consensus proposal information may be created based on a consensus batch identifier of one or more of the consensus batches that pass the integrity check. The integrity check is a process of checking whether a broadcast batch corresponding to a consensus batch is complete, and if no broadcast batch corresponding to the consensus batch is lost, the consensus batch passes the integrity check. For example, that the quantity of consensus batches that pass the integrity check meets the consensus proposal condition may mean: the quantity of consensus batches that pass the integrity check is greater than or equal to a fourth quantity threshold. The fourth quantity threshold may be a preset value. For example, the fourth quantity threshold may be 3 or 5. This is not limited in the embodiments of the present disclosure.

In more detail, the broadcast batch received by the leader node may be stored in a transaction pool of the leader node. A process in which the integrity check is performed, based on the received broadcast batch, on the broadcast batch corresponding to the received consensus batch may include the following operations. Broadcast batch query is performed on the transaction pool of the leader node based on the broadcast batch identifier in the received consensus batch; if a corresponding broadcast batch can be found in the transaction pool of the leader node based on the broadcast batch identifier in the received consensus batch, a query result indicating that no broadcast batch corresponding to the received consensus batch is lost may be generated, and the received consensus batch passes the integrity check; or if a broadcast batch corresponding to a part of broadcast batches in the received consensus batch cannot be found in the transaction pool of the leader node, a query result indicating that a broadcast batch corresponding to the received consensus batch is lost may be generated, and if the query result indicates that a broadcast batch corresponding to the received consensus batch is lost, the lost broadcast batch may be obtained from the transaction receiving node; and when the lost broadcast batch returned by the transaction receiving node is received, it may be determined that the received consensus batch passes the integrity check.

When the quantity of consensus batches that pass the integrity check meets the consensus proposal condition (for example, the quantity of consensus batches that pass the integrity check is greater than or equal to the fourth quantity threshold), a consensus batch whose quantity is the fourth quantity threshold may be selected from the consensus batches that pass the integrity check in a sequence of integrity check passing time, and the consensus proposal information is created based on a consensus batch identifier of the selected consensus batch. Each consensus batch proposed by the leader node is a consensus batch that passes the integrity check. In other words, the transaction pool of the leader node stores a complete broadcast batch corresponding to the proposed consensus batch.

S1002: Broadcast the consensus proposal information to a follower node.

After the consensus proposal information is created, the leader node may broadcast the consensus proposal information to the follower node. After receiving the consensus proposal information, if it is determined, based on the consensus batch identifier in the consensus proposal information, that a consensus batch is incomplete in a transaction pool of the follower node, the follower node may obtain a batch structure of the incomplete consensus batch, determine, based on the batch structure of the incomplete consensus batch, that a broadcast batch corresponding to the incomplete consensus batch is incomplete, and obtain the incomplete broadcast batch from the leader node (for example, make a request to the leader node for obtaining the incomplete broadcast batch).

S1003: Return the incomplete broadcast batch to the follower node.

If the follower node makes a request to the leader node for obtaining the incomplete broadcast batch, the leader node may return the incomplete broadcast batch to the follower node, so that the follower node may recover, based on a transaction on which consensus is to be reached in the incomplete broadcast batch, the transaction that requires consensus and that is proposed in the consensus proposal information, and reach consensus on the recovered transaction that requires consensus.

In the embodiments of the present disclosure, the consensus proposal information includes the consensus batch identifier rather than consensus batch content or the broadcast batch identifier. In this way, more transactions that require consensus can be proposed in the consensus proposal information, thereby improving the consensus efficiency. In addition, after receiving the consensus batch broadcast by the transaction receiving node, the leader node may check and fill in a gap in the broadcast batch corresponding to the broadcast consensus batch in time. If a broadcast batch is lost, the lost broadcast batch is obtained from the transaction receiving node in time. In this way, it can be ensured that the transaction pool of the leader node stores a complete broadcast batch corresponding to a proposed consensus batch, so that the leader node can quickly feed back when the follower node obtains an incomplete broadcast batch corresponding to the consensus batch proposed in the consensus proposal information from the leader node, to improve the consensus efficiency.

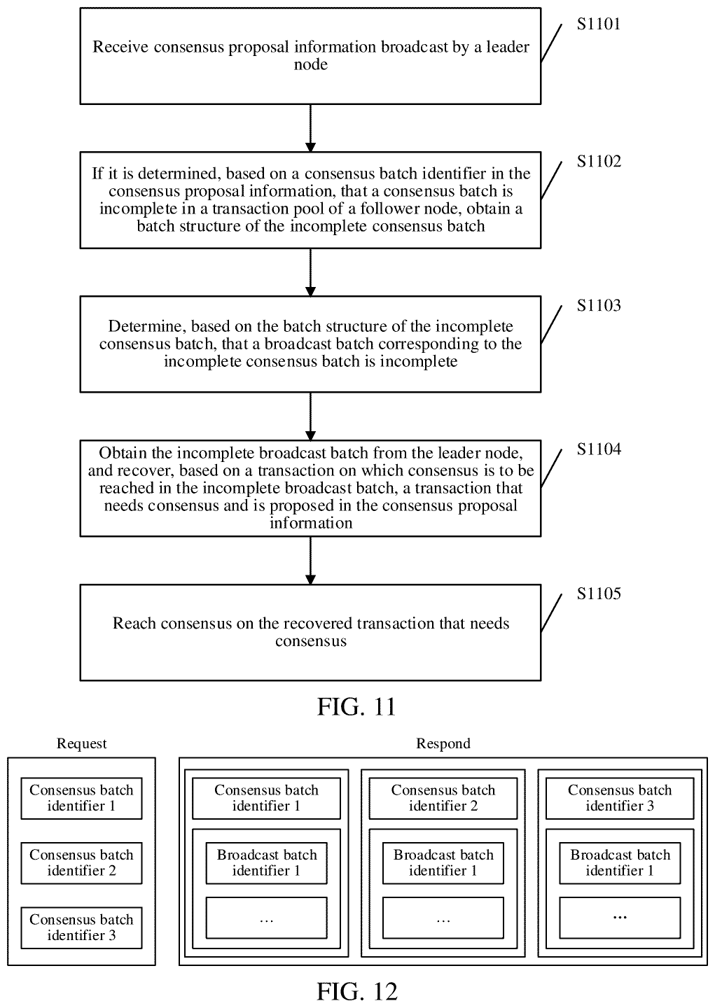

An embodiment of the present disclosure provides a method for data processing based on a blockchain network. The method for data processing based on a blockchain network includes a consensus process after a follower node receives consensus proposal information. The method for data processing based on a blockchain network may be performed by a follower node in a blockchain network. As shown in FIG. 11, the method for data processing based on a blockchain network may include at least the following S1101 to S1105.

S1101: Receive consensus proposal information broadcast by a leader node.

The consensus proposal information broadcast by the leader node and received by the follower node may be configured for proposing a transaction that requires consensus. The consensus proposal information may include one or more consensus batch identifiers, and each consensus batch identifier is configured to distinctively identify a corresponding consensus batch. A batch structure of each consensus batch may include one or more broadcast batch identifiers, and each broadcast batch identifier is configured to distinctively identify a corresponding broadcast batch. A batch structure of each broadcast batch may include one or more transactions on which consensus is to be reached.

S1102: If it is determined, based on the consensus batch identifier in the consensus proposal information, that a consensus batch is incomplete in a transaction pool of the follower node, obtain a batch structure of the incomplete consensus batch.

After the consensus proposal information broadcast by the leader node is received, if it is determined, based on the consensus batch identifier in the consensus proposal information, that a consensus batch is incomplete in the transaction pool of the follower node, a batch structure of the incomplete consensus batch may be obtained. The transaction pool of the follower node may be configured to store a broadcast batch and a consensus batch that are broadcast by the transaction receiving node.

In a transmission process of the consensus batch, the consensus batch may be lost, and in a transmission process of the broadcast batch, the broadcast batch may also be lost. Therefore, after the follower node receives the consensus proposal information broadcast by the leader node, a consensus batch proposed in the consensus proposal information may be incomplete in the transaction pool of the follower node. That a consensus batch is incomplete in the transaction pool of the follower node may include any one of the following cases. An entire consensus batch is missing (in other words, the entire consensus batch is not stored in the transaction pool of the follower node), or a part of broadcast batches corresponding to the consensus batch is missing (in other words, a part of the broadcast batches corresponding to the consensus batch is not stored in the transaction pool of the follower node, in other words, the consensus batch is not completely stored in the transaction pool of the follower node). The following respectively describes a process of determining that a consensus batch is incomplete in the transaction pool of the follower node and a process of obtaining the incomplete consensus batch in the two cases.

For a case in which an entire consensus batch is missing, the transaction pool of the follower node may be searched for a corresponding consensus batch based on the consensus batch identifier in the consensus proposal information. If a consensus batch corresponding to a target consensus batch identifier in the consensus proposal information is not found in the transaction pool of the follower node, it may be determined that a consensus batch is missing in the transaction pool of the follower node. The consensus batch corresponding to the target consensus batch identifier is the missing consensus batch. In this case, a batch structure of the missing consensus batch does not exist in the transaction pool of the follower node, so that the batch structure of the missing consensus batch requires to be obtained from the leader node.

For a case in which a part of broadcast batches corresponding to the consensus batch is missing, the transaction pool of the follower node may be searched for a corresponding consensus batch based on the consensus batch identifier in the consensus proposal information. The transaction pool of the follower node is searched for a corresponding broadcast batch based on a broadcast batch identifier in a found consensus batch. If a broadcast batch corresponding to a target broadcast batch identifier is not found in the transaction pool of the follower node, it may be determined that a consensus batch is incomplete in the transaction pool of the follower node. The target broadcast batch identifier is a broadcast batch identifier in the found consensus batch. A consensus batch to which the target broadcast batch identifier belongs is the incomplete consensus batch. In this case, a batch structure of the incomplete consensus batch exists in the transaction pool of the follower node, so that the batch structure of the incomplete consensus batch may be obtained from the transaction pool of the follower node.

In other words, if the batch structure of the incomplete consensus batch exists in the transaction pool of the follower node, the batch structure of the incomplete consensus batch may be obtained from the transaction pool of the follower node; or if the batch structure of the incomplete consensus batch does not exist in the transaction pool of the follower node, the batch structure of the incomplete consensus batch is obtained from the leader node.

S1103: Determine, based on the batch structure of the incomplete consensus batch, that a broadcast batch corresponding to the incomplete consensus batch is incomplete.

After the batch structure of the incomplete consensus batch is obtained, it may be determined, based on the batch structure of the incomplete consensus batch, that the broadcast batch corresponding to the incomplete consensus batch is incomplete. Specifically, the transaction pool of the follower node may be searched for a corresponding broadcast batch based on a broadcast batch identifier in the batch structure of the incomplete consensus batch. If a corresponding broadcast batch is not found in the transaction pool of the follower node based on a reference broadcast batch identifier in the batch structure of the incomplete consensus batch, the broadcast batch corresponding to the reference broadcast batch identifier may be determined as the incomplete broadcast batch corresponding to the incomplete consensus batch.

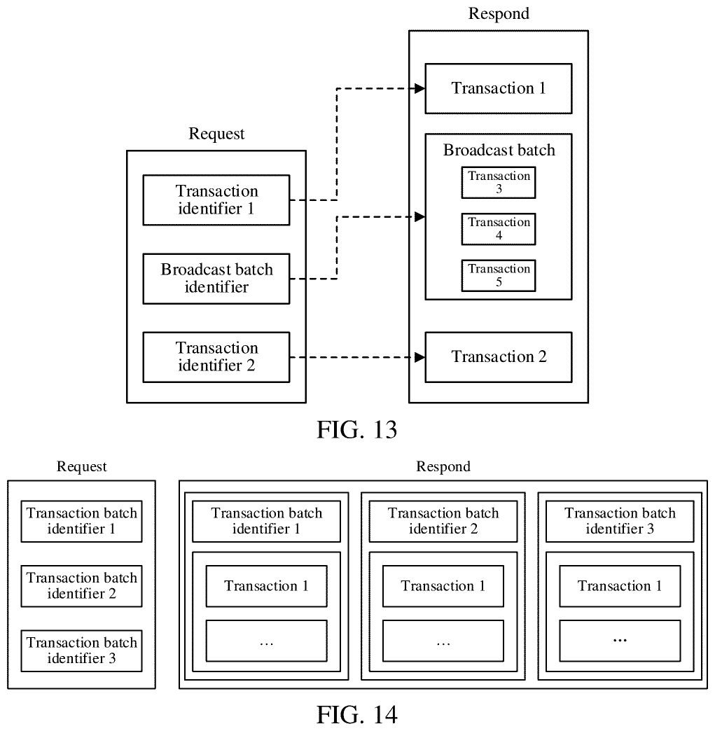

In other words, regardless of a case in which an entire consensus batch is missing or a case in which a part of the broadcast batches corresponding to the consensus batch is missing, in the embodiments of the present disclosure, not all of the broadcast batches corresponding to the incomplete consensus batch are fully obtained. Instead, as shown in FIG. 12, in this embodiment of the present disclosure, the follower node requests to obtain the batch structure of the incomplete consensus batch, and determines, based on the batch structure of the incomplete consensus batch obtained through a response of the leader node, that the broadcast batch corresponding to the incomplete consensus batch is incomplete. In addition, as shown in FIG. 13, the follower node makes a request to the leader node for obtaining the incomplete broadcast batch, and obtains the incomplete broadcast batch based on a response of the leader node. Some broadcast batches in FIG. 13 include only one transaction on which consensus is to be reached. Therefore, a transaction identifier of the transaction on which consensus is to be reached may be directly used as the broadcast batch identifier. This is because the follower node may already obtain a part of the broadcast batches corresponding to the incomplete consensus batch from the transaction receiving node, and only another part of the broadcast batches is incomplete. If all of the broadcast batches corresponding to the incomplete consensus batch are fully obtained, consensus efficiency is affected. Compared with the method for data processing based on a blockchain network shown in FIG. 4 and FIG. 5, as shown in FIG. 14, if the method for data processing based on a blockchain network shown in FIG. 4 and FIG. 5 is used, if the follower node misses a part of transaction batches proposed in the consensus proposal information, the follower node requires to make a request to the leader node for fully obtaining all of the transaction batches. As a result, an obtained data volume is large, and the consensus efficiency is affected.

S1104: Obtain the incomplete broadcast batch from the leader node, and recover, based on a transaction on which consensus is to be reached in the incomplete broadcast batch, the transaction that requires consensus and is proposed in the consensus proposal information.

After the incomplete broadcast batch is determined, the incomplete broadcast batch may be obtained from the leader node, and the transaction that requires consensus and is proposed in the consensus proposal information is recovered based on the transaction on which consensus is to be reached in the incomplete broadcast batch.

S1105: Reach consensus on the recovered transaction that requires consensus.

After the transaction that requires consensus in the consensus proposal information is recovered, consensus may be reached on the recovered transaction that requires consensus.

The foregoing operation S1101 to operation S1105 describe a procedure of the follower node at a transaction consensus stage. For a procedure of the follower node at a transaction broadcast stage, reference may be made to the following descriptions. The follower node may receive the broadcast batch broadcast by the transaction receiving node, and add the received broadcast batch to the transaction pool of the follower node. The received broadcast batch is generated by the transaction receiving node, when a quantity of received transactions on which consensus is to be reached meets a broadcast batch packaging condition, based on one or more of the received transactions on which consensus is to be reached. The follower node receives the consensus batch broadcast by the transaction receiving node, and performs broadcast batch query on the transaction pool of the follower node based on the broadcast batch identifier in the received consensus batch. If a query result indicates that a broadcast batch corresponding to the received consensus batch is lost, the lost broadcast batch may be obtained from the transaction receiving node. The received consensus batch may be generated by the transaction receiving node, when a quantity of generated broadcast batches meets a consensus batch packaging condition, based on a broadcast batch identifier of one or more of the generated broadcast batches.

In the embodiments of the present disclosure, consensus proposal information includes one or more consensus batch identifiers instead of consensus batch content. In this way, more transactions that require consensus can be proposed in the consensus proposal information, thereby improving the consensus efficiency. Moreover, if it is determined, based on the consensus batch identifier in the consensus proposal information, that a consensus batch is incomplete in a transaction pool of a follower node, a batch structure of the incomplete consensus batch may be obtained, it is determined, based on a batch structure of the incomplete consensus batch, that a broadcast batch corresponding to the incomplete consensus batch is incomplete, and the incomplete broadcast batch is obtained from the leader node. In other words, if a consensus batch is incomplete in the transaction pool of the follower node, an incomplete broadcast batch corresponding to the incomplete consensus batch is obtained from the leader node instead of all broadcast batches corresponding to the incomplete consensus batch. In this way, a data volume obtained from the leader node can be reduced, thereby further improving the consensus efficiency.

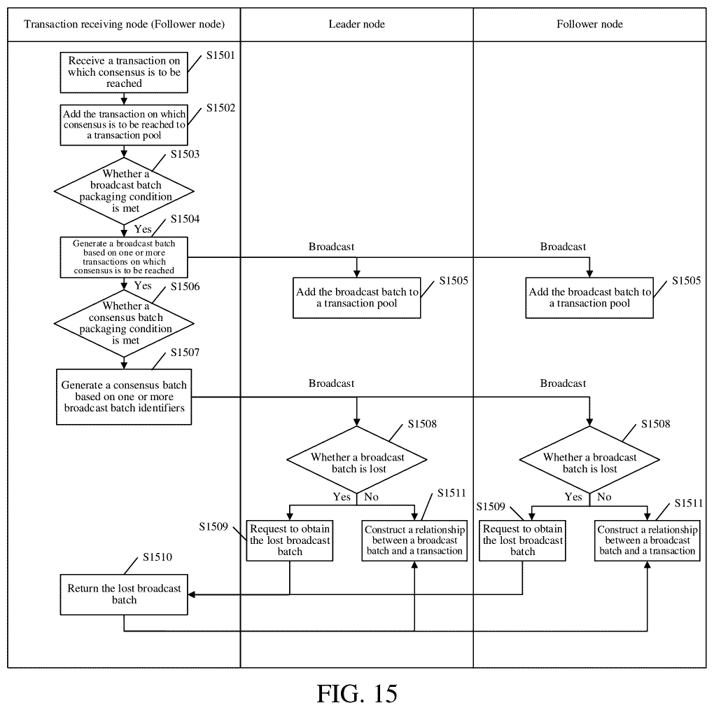

An embodiment of the present disclosure provides a method for data processing based on a blockchain network. The method for data processing based on a blockchain network includes an interaction procedure between a transaction receiving node, a leader node, and a follower node at a transaction broadcast stage and a transaction consensus stage. The method for data processing based on a blockchain network may be interactively performed by the transaction receiving node, the leader node, and the follower node in the blockchain network. As shown in FIG. 15, the method for data processing based on a blockchain network may include at least operation S1501 to operation S1511 below for the transaction broadcast stage.

S1501: The transaction receiving node receives a transaction on which consensus is to be reached.

S1502: The transaction receiving node adds the transaction on which consensus is to be reached to a transaction pool of the transaction receiving node.

S1503: The transaction receiving node determines whether a quantity of transactions on which consensus is to be reached received in the transaction pool of the transaction receiving node meets a broadcast batch packaging condition.

S1504: If the quantity of transactions on which consensus is to be reached received from the transaction pool of the transaction receiving node meets the broadcast batch packaging condition, the transaction receiving node generates a broadcast batch based on one or more of the received transactions on which consensus is to be reached, and broadcasts the broadcast batch to other nodes (including the leader node and follower node) in the blockchain network than the transaction receiving node.

S1505: The leader node (or the follower node) adds the broadcast batch to a transaction pool of the leader node (or the follower node).

S1506: The transaction receiving node determines whether a quantity of generated broadcast batches meets a consensus batch packaging condition.

S1507: When the quantity of generated broadcast batches meets the consensus batch packaging condition, the transaction receiving node generates a consensus batch based on a broadcast batch identifier of one or more of the generated broadcast batches and broadcasts the consensus batch to other nodes (including the leader node and follower node) in the blockchain network than the transaction receiving node.

S1508: The leader node (or the follower node) determines whether a broadcast batch corresponding to the received consensus batch is lost.

S1509: If the broadcast batch is lost in the received consensus batch, the leader node (or the follower node) requests the transaction receiving node to obtain the lost broadcast batch. If no broadcast batch is lost in the received consensus batch, perform operation S1511.

S1510: The transaction receiving node returns the lost broadcast batch to the leader node (or the follower node).

S1511: The leader node (or the follower node) constructs a relationship between a broadcast batch and a transaction in the broadcast batch.

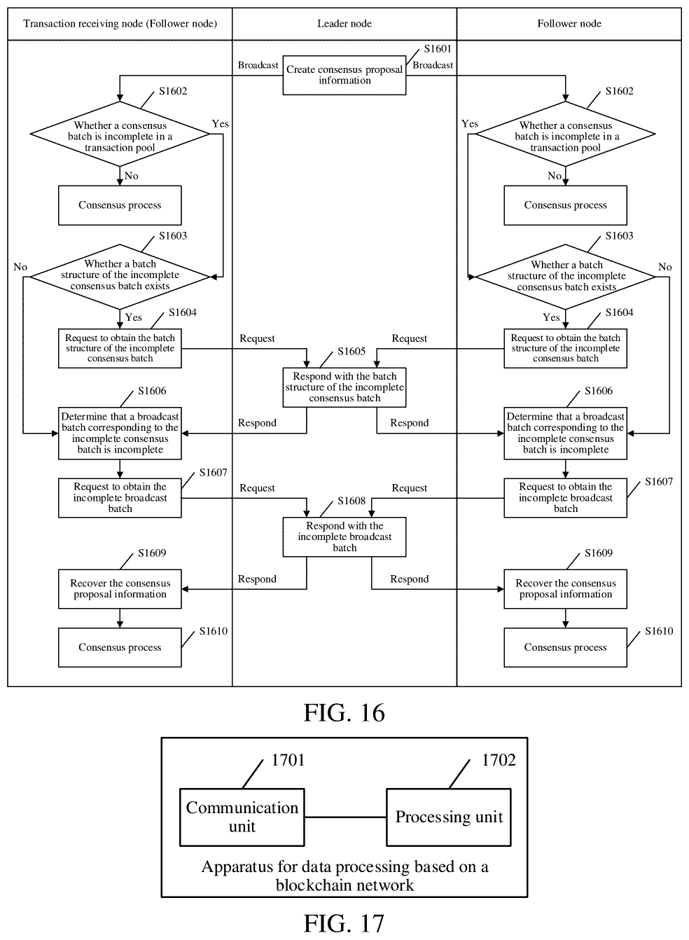

As shown in FIG. 16, the method for data processing based on a blockchain network may include at least the following operation S1601 to operation S1610 for the transaction consensus stage.

S1601: The leader node creates consensus proposal information, and broadcasts the consensus proposal information to the follower node.

S1602: The follower node determines, based on a consensus batch identifier in the consensus proposal information, whether a consensus batch is incomplete in the transaction pool of the follower node.

S1603: If the incomplete consensus batch exists in the transaction pool of the follower node, the follower node determines whether a batch structure of the incomplete consensus batch exists in the transaction pool of the follower node. If no incomplete consensus batch exists in the transaction pool of the follower node, reach consensus on a transaction that requires consensus and is proposed in the consensus proposal information.

If the batch structure of the incomplete consensus batch exists in the transaction pool of the follower node, perform operation S1604 and operation S1605. If the batch structure of the incomplete consensus batch does not exist in the transaction pool of the follower node, perform operation S1606.

S1604: The follower node requests the leader node to obtain the batch structure of the incomplete consensus batch.

S1605: The leader node returns the batch structure of the incomplete consensus batch to the follower node.

S1606: The follower node determines, based on the batch structure of the incomplete consensus batch, that a broadcast batch corresponding to the incomplete consensus batch is incomplete.

S1607: The follower node requests to obtain the incomplete broadcast batch from the leader node.

S1608: The leader node returns the incomplete broadcast batch to the follower node.

S1609: The follower node recovers, based on the incomplete broadcast batch, a transaction that requires consensus and is proposed in the consensus proposal information.

S1610: The follower node reaches consensus on the recovered transaction that requires consensus.

In the embodiments of the present disclosure, consensus proposal information includes one or more consensus batch identifiers instead of consensus batch content. In this way, more transactions that require consensus can be proposed in the consensus proposal information, thereby improving the consensus efficiency. Moreover, if it is determined, based on the consensus batch identifier in the consensus proposal information, that a consensus batch is incomplete in a transaction pool of a follower node, a batch structure of the incomplete consensus batch may be obtained, it is determined, based on a batch structure of the incomplete consensus batch, that a broadcast batch corresponding to the incomplete consensus batch is incomplete, and the incomplete broadcast batch is obtained from the leader node. In other words, if a consensus batch is incomplete in the transaction pool of the follower node, an incomplete broadcast batch corresponding to the incomplete consensus batch is obtained from the leader node instead of all broadcast batches corresponding to the incomplete consensus batch. In this way, a data volume obtained from the leader node can be reduced, thereby further improving the consensus efficiency.

FIG. 17 is a schematic structural diagram of an apparatus for data processing based on a blockchain network according to an embodiment of the present disclosure.

In an embodiment, the apparatus for data processing based on a blockchain network may be disposed in a computer device provided in the embodiments of the present disclosure, and the computer device may be a follower node in a blockchain network. The apparatus for data processing based on a blockchain network shown in FIG. 17 may be a computer program (including program code) running in a computer device. The apparatus for data processing based on a blockchain network may be configured to perform some or all of the operations performed by the follower node in the method embodiment shown in FIG. 11, FIG. 15, or FIG. 16. Referring to FIG. 17, the apparatus for data processing based on a blockchain network may include the following units:
a communication unit 1701, configured to receive consensus proposal information broadcast by the leader node, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached; and
a processing unit 1702, configured to obtain, if it is determined, based on the consensus batch identifier in the consensus proposal information, that a consensus batch is incomplete in a transaction pool of the follower node, a batch structure of the incomplete consensus batch, the transaction pool of the follower node being configured to store a broadcast batch and a consensus batch broadcast by the transaction receiving node.

The processing unit 1702 is further configured to determine, based on the batch structure of the incomplete consensus batch, that a broadcast batch corresponding to the incomplete consensus batch is incomplete;
the processing unit 1702 is further configured to obtain the incomplete broadcast batch from the leader node, and recover, based on a transaction on which consensus is to be reached in the incomplete broadcast batch, the transaction that requires consensus and is proposed in the consensus proposal information; and
the processing unit 1702 is further configured to reach consensus on the recovered transaction that requires consensus.

In an implementation, the processing unit 1702 is further configured to perform the following operations:
searching the transaction pool of the follower node for a corresponding consensus batch based on the consensus batch identifier in the consensus proposal information; and
if a consensus batch corresponding to a target consensus batch identifier in the consensus proposal information is not found in the transaction pool of the follower node, determining that a consensus batch is missing in the transaction pool of the follower node.

The consensus batch corresponding to the target consensus batch identifier is the missing consensus batch.

In an implementation, the processing unit 1702 is further configured to perform the following operations:
searching the transaction pool of the follower node for a corresponding consensus batch based on the consensus batch identifier in the consensus proposal information; and
searching the transaction pool of the follower node for a corresponding broadcast batch based on a broadcast batch identifier in a found consensus batch; and
if a broadcast batch corresponding to a target broadcast batch identifier is not found in the transaction pool of the follower node, determining that a consensus batch is incomplete in the transaction pool of the follower node.

The target broadcast batch identifier is a broadcast batch identifier in the found consensus batch. A consensus batch to which the target broadcast batch identifier belongs is the incomplete consensus batch.

In an implementation, the communication unit 1701 is further configured to perform the following operations:
receiving a broadcast batch broadcast by the transaction receiving node, the received broadcast batch being generated by the transaction receiving node, when a quantity of received transactions on which consensus is to be reached meets a broadcast batch packaging condition, based on one or more of the received transactions on which consensus is to be reached; and
adding the received broadcast batch to the transaction pool of the follower node.

In an implementation, the communication unit 1701 is further configured to perform the following operations:
receiving a consensus batch broadcast by the transaction receiving node, the received consensus batch being generated by the transaction receiving node, when a quantity of generated broadcast batches meets a consensus batch packaging condition, based on a broadcast batch identifier of one or more of the generated broadcast batches;
performing broadcast batch query on the transaction pool of the follower node based on the broadcast batch identifier in the received consensus batch;
if a query result indicates that a broadcast batch corresponding to the received consensus batch is lost, obtaining the lost broadcast batch from the transaction receiving node; and
adding the lost broadcast batch to the transaction pool of the follower node.

In an implementation, the processing unit 1702 is specifically configured to perform the following operations when being configured to obtain the batch structure of the incomplete consensus batch:
obtaining the batch structure of the incomplete consensus batch from the transaction pool of the follower node if the batch structure of the incomplete consensus batch exists in the transaction pool of the follower node; or
obtaining the batch structure of the incomplete consensus batch from the leader node if the batch structure of the incomplete consensus batch does not exist in the transaction pool of the follower node.

According to another embodiment of the present disclosure, the units of the apparatus for data processing based on a blockchain network shown in FIG. 17 may be separately or all combined into one or several other units, or one (or more) of the units may further be divided into a plurality of units of smaller functions. In this way, same operations can be implemented without affecting implementation of the technical effects of the embodiments of the present disclosure. The foregoing units are divided based on logical functions. In an actual application, a function of one unit may alternatively be implemented by a plurality of units, or functions of a plurality of units are implemented by one unit. In another embodiment of the present disclosure, the apparatus for data processing based on a blockchain network may further include another unit. In an actual application, these functions may alternatively be cooperatively implemented by another unit, and may be cooperatively implemented by a plurality of units.

According to another embodiment of the present disclosure, a computer program (including program code) that can perform operations of the follower node in some or all of the methods shown in FIG. 11, FIG. 15, or FIG. 16 may be run on a universal computing device, such as a computer, that includes processing elements and storage elements such as a central processing unit (CPU), a random access storage medium (RAM), and a read-only storage medium (ROM), to construct the apparatus for data processing based on a blockchain network shown in FIG. 17, and to implement the method for data processing for a blockchain network in the embodiments of the present disclosure. The computer program may be recorded in, for example, a computer-readable storage medium, loaded on the computing device by using the computer-readable storage medium, and run in the computing device.

In the embodiments of the present disclosure, consensus proposal information includes one or more consensus batch identifiers instead of consensus batch content. In this way, more transactions that require consensus can be proposed in the consensus proposal information, thereby improving the consensus efficiency. Moreover, if it is determined, based on the consensus batch identifier in the consensus proposal information, that a consensus batch is incomplete in a transaction pool of a follower node, a batch structure of the incomplete consensus batch may be obtained, it is determined, based on a batch structure of the incomplete consensus batch, that a broadcast batch corresponding to the incomplete consensus batch is incomplete, and the incomplete broadcast batch is obtained from the leader node. In other words, if a consensus batch is incomplete in the transaction pool of the follower node, an incomplete broadcast batch corresponding to the incomplete consensus batch is obtained from the leader node instead of all broadcast batches corresponding to the incomplete consensus batch. In this way, a data volume obtained from the leader node can be reduced, thereby further improving the consensus efficiency.

In another embodiment, the apparatus for data processing based on a blockchain network may be disposed in a computer device provided in the embodiments of this disclosure, and the computer device may be a leader node in a blockchain network. The apparatus for data processing based on a blockchain network shown in FIG. 17 may be a computer program (including program code) running in a computer device. The apparatus for data processing based on a blockchain network may be configured to perform some or all of the operations performed by the leader node in the method embodiment shown in FIG. 10, FIG. 15, or FIG. 16. Referring to FIG. 17, the apparatus for data processing based on a blockchain network may include the following units:
a processing unit 1702, configured to create consensus proposal information, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached; and
a communication unit 1701, configured to broadcast the consensus proposal information to the follower node, to cause the follower node to obtain, if it is determined, based on the consensus batch identifier in the consensus proposal information, that a consensus batch is incomplete in a transaction pool of the follower node, a batch structure of the incomplete consensus batch after receiving the consensus proposal information, determine, based on the batch structure of the incomplete consensus batch, that a broadcast batch corresponding to the incomplete consensus batch is incomplete, and obtain the incomplete broadcast batch from the leader node, the transaction pool of the follower node being configured to store a broadcast batch and a consensus batch broadcast by the transaction receiving node.

The communication unit 1701 is further configured to return the incomplete broadcast batch to the follower node, to cause the follower node to recover, based on a transaction on which consensus is to be reached in the incomplete broadcast batch, the transaction that requires consensus and is proposed in the consensus proposal information, and reach consensus on the recovered transaction that requires consensus.

In an implementation, the processing unit 1702 is specifically configured to perform the following operations when being configured to create the consensus proposal information:
receiving a broadcast batch broadcast by the transaction receiving node, the received broadcast batch being generated by the transaction receiving node, when a quantity of received transactions on which consensus is to be reached meets a broadcast batch packaging condition, based on one or more of the received transactions on which consensus is to be reached; and
receiving a consensus batch broadcast by the transaction receiving node, the received consensus batch being generated by the transaction receiving node, when a quantity of generated broadcast batches meets a consensus batch packaging condition, based on a broadcast batch identifier of one or more of the generated broadcast batches;
performing an integrity check on the broadcast batch corresponding to the received consensus batch based on the received broadcast batch; and
when a quantity of consensus batches that pass the integrity check meets the consensus proposal condition, creating the consensus proposal information based on a consensus batch identifier of one or more of the consensus batches that pass the integrity check.

In an implementation, the received broadcast batch is added to a transaction pool of the leader node. The processing unit 1702 is specifically configured to perform the following operations when performing an integrity check on the broadcast batch corresponding to the received consensus batch based on the received broadcast batch:
performing broadcast batch query on the transaction pool of the leader node based on a broadcast batch identifier in the received consensus batch;
if a query result indicates that a broadcast batch corresponding to the received consensus batch is lost, obtaining the lost broadcast batch from the transaction receiving node; and
determining that the received consensus batch passes the integrity check when receiving the lost broadcast batch returned by the transaction receiving node.

According to another embodiment of the present disclosure, the units of the apparatus for data processing based on a blockchain network shown in FIG. 17 may be separately or all combined into one or several other units, or one (or more) of the units may further be divided into a plurality of units of smaller functions. In this way, same operations can be implemented without affecting implementation of the technical effects of the embodiments of this application. The foregoing units are divided based on logical functions. In an actual application, a function of one unit may alternatively be implemented by a plurality of units, or functions of a plurality of units are implemented by one unit. In another embodiment of the present disclosure, the apparatus for data processing based on a blockchain network may further include another unit. In an actual application, these functions may alternatively be cooperatively implemented by another unit, and may be cooperatively implemented by a plurality of units.

According to another embodiment of the present disclosure, a computer program (including program code) that can perform operations of the leader node in some or all of the methods shown in FIG. 10, FIG. 15, or FIG. 16 may be run on a universal computing device, such as a computer, that includes processing elements and storage elements such as a central processing unit (CPU), a random access storage medium (RAM), and a read-only storage medium (ROM), to construct the apparatus for data processing based on a blockchain network shown in FIG. 17, and to implement the method for data processing for a blockchain network in the embodiments of the present disclosure. The computer program may be recorded in, for example, a computer-readable storage medium, loaded on the computing device by using the computer-readable storage medium, and run in the computing device.

In the embodiments of the present disclosure, the consensus proposal information includes a consensus batch identifier of one or more consensus batches instead of batch content of the one or more consensus batches. In this way, more transactions that require consensus can be proposed in the consensus proposal information, thereby improving the consensus efficiency. Moreover, if it is determined, based on the consensus batch identifier in the consensus proposal information, that a consensus batch is incomplete in a transaction pool of a follower node, a batch structure of the incomplete consensus batch may be obtained, it is determined, based on a batch structure of the incomplete consensus batch, that a broadcast batch corresponding to the incomplete consensus batch is incomplete, and the incomplete broadcast batch is obtained from the leader node. In other words, if a consensus batch is incomplete in the transaction pool of the follower node, an incomplete broadcast batch corresponding to the incomplete consensus batch is obtained from the leader node instead of all broadcast batches corresponding to the incomplete consensus batch. In this way, a data volume obtained from the leader node can be reduced, thereby further improving the consensus efficiency.

In another embodiment, the apparatus for data processing based on a blockchain network may be disposed in a computer device provided in the embodiments of the present disclosure, and the computer device may be a transaction receiving node in a blockchain network. The apparatus for data processing based on a blockchain network shown in FIG. 17 may be a computer program (including program code) running in a computer device. The apparatus for data processing based on a blockchain network may be configured to perform some or all of the operations performed by the transaction receiving node in the method embodiment shown in FIG. 6, FIG. 15, or FIG. 16. Referring to FIG. 17, the apparatus for data processing based on a blockchain network may include the following units:
a communication unit 1701, configured to receive a transaction on which consensus is to be reached; and
a processing unit 1702, configured to generate, when a quantity of received transactions on which consensus is to be reached meets a broadcast batch packaging condition, a broadcast batch based on one or more of the received transactions on which consensus is to be reached, and broadcast the broadcast batch to the leader node and the follower node.

The processing unit 1702 is further configured to generate, when a quantity of the generated broadcast batches meets a consensus batch packaging condition, a consensus batch based on a broadcast batch identifier of one or more of the generated broadcast batches;
the processing unit 1702 is further configured to broadcast the consensus batch to the leader node, to cause the leader node to create consensus proposal information based on the consensus batch, and broadcast the consensus proposal information to the follower node, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached; and
the processing unit 1702 is further configured to: broadcast the consensus batch to the follower node, to cause the follower node to obtain, if it is determined, based on the consensus batch identifier in the consensus proposal information, that a consensus batch is incomplete in a transaction pool of the follower node, a batch structure of the incomplete consensus batch after receiving the consensus proposal information, and determine, based on the batch structure of the incomplete consensus batch, that a broadcast batch corresponding to the incomplete consensus batch is incomplete; obtain the incomplete broadcast batch from the leader node, and recover, based on a transaction on which consensus is to be reached in the incomplete broadcast batch, the transaction that requires consensus and is proposed in the consensus proposal information; and reach consensus on the recovered transaction that requires consensus, the transaction pool of the follower node being configured to store a broadcast batch and a consensus batch broadcast by the transaction receiving node.

According to another embodiment of the present disclosure, the units of the apparatus for data processing based on a blockchain network shown in FIG. 17 may be separately or all combined into one or several other units, or one (or more) of the units may further be divided into a plurality of units of smaller functions. In this way, same operations can be implemented without affecting implementation of the technical effects of the embodiments of the present disclosure. The foregoing units are divided based on logical functions. In an actual application, a function of one unit may alternatively be implemented by a plurality of units, or functions of a plurality of units are implemented by one unit. In another embodiment of the present disclosure, the apparatus for data processing based on a blockchain network may further include another unit. In an actual application, these functions may alternatively be cooperatively implemented by another unit, and may be cooperatively implemented by a plurality of units.

According to another embodiment of the present disclosure, a computer program (including program code) that can perform operations of the leader node in some or all of the methods shown in FIG. 6, FIG. 15, or FIG. 16 may be run on a universal computing device, such as a computer, that includes processing elements and storage elements such as a central processing unit (CPU), a random access storage medium (RAM), and a read-only storage medium (ROM), to construct the apparatus for data processing based on a blockchain network shown in FIG. 17, and to implement the method for data processing for a blockchain network in the embodiments of the present disclosure. The computer program may be recorded in, for example, a computer-readable storage medium, loaded on the computing device by using the computer-readable storage medium, and run in the computing device.

In the embodiments of the present disclosure, the consensus proposal information includes a consensus batch identifier of one or more consensus batches instead of batch content of the one or more consensus batches. In this way, more transactions that require consensus can be proposed in the consensus proposal information, thereby improving the consensus efficiency. Moreover, if it is determined, based on the consensus batch identifier in the consensus proposal information, that a consensus batch is incomplete in a transaction pool of a follower node, a batch structure of the incomplete consensus batch may be obtained, it is determined, based on a batch structure of the incomplete consensus batch, that a broadcast batch corresponding to the incomplete consensus batch is incomplete, and the incomplete broadcast batch is obtained from the leader node. In other words, if a consensus batch is incomplete in the transaction pool of the follower node, an incomplete broadcast batch corresponding to the incomplete consensus batch is obtained from the leader node instead of all broadcast batches corresponding to the incomplete consensus batch. In this way, a data volume obtained from the leader node can be reduced, thereby further improving the consensus efficiency.

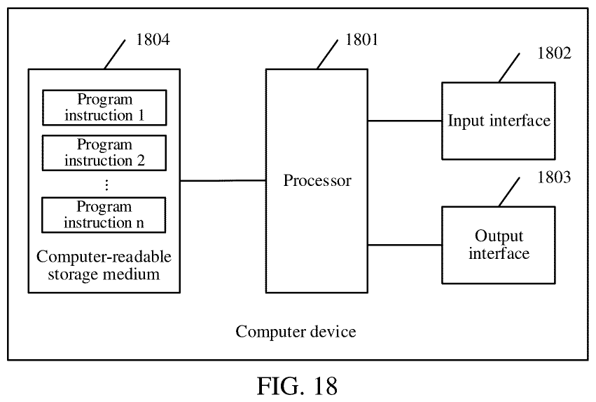

Based on the foregoing method and apparatus embodiments, an embodiment of the present disclosure provides a computer device. FIG. 18 is a schematic structural diagram of a computer device according to an embodiment of the present disclosure. The computer device shown in FIG. 18 includes at least a processor 1801, an input interface 1802, an output interface 1803, and a computer-readable storage medium 1804. The processor 1801, the input interface 1802, the output interface 1803, and the computer-readable storage medium 1804 may be connected through a bus or in another manner.

The computer-readable storage medium 1804 may be stored in a memory of the computer device. The computer-readable storage medium 1804 is configured to store a computer program. The computer program includes computer instructions. The processor 1801 is configured to execute the program instructions stored in the computer-readable storage medium 1804. The processor 1801 (or referred to as a central processing unit (CPU)) is a computing core and a control core of the computer device. The processor 1801 is configured to implement one or more computer instructions, and is specifically configured to load and execute one or more computer instructions, to implement a corresponding method procedure or a corresponding function.

An embodiment of the present disclosure further provides a computer-readable storage medium (memory). The computer-readable storage medium is a memory device in a computer device, and is configured to store a program and data. The computer-readable storage medium herein may include a built-in storage medium in the computer device, and certainly may include an extended storage medium supported by the computer device. The computer-readable storage medium provides storage space, and the storage space stores an operating system of the computer device. In addition, the storage space further stores one or more computer instructions configured to be loaded and executed by a processor. The computer instructions may be one or more computer programs (including program code). The computer-readable storage medium herein may be a high-speed RAM memory, or may be a non-volatile memory, for example, at least one magnetic disk memory. In some embodiments, the computer-readable storage medium may be at least one computer-readable storage medium located far from the foregoing processor.

In some embodiments, the computer device may be a follower node in a blockchain network, and the processor 1801 may load and execute one or more computer instructions stored in the computer-readable storage medium 1804, to implement corresponding operations performed by the follower node in the foregoing method for data processing based on a blockchain network shown in FIG. 11, FIG. 15, or FIG. 16. During specific implementation, the computer instructions in the computer-readable storage medium 1804 are loaded by the processor 1801 to perform the following operations:
receiving consensus proposal information broadcast by the leader node, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached; and
if it is determined, based on the consensus batch identifier in the consensus proposal information, that a consensus batch is incomplete in a transaction pool of the follower node, obtaining a batch structure of the incomplete consensus batch, the transaction pool of the follower node being configured to store a broadcast batch and a consensus batch broadcast by the transaction receiving node;
determining, based on the batch structure of the incomplete consensus batch, that a broadcast batch corresponding to the incomplete consensus batch is incomplete;
obtaining the incomplete broadcast batch from the leader node, and recovering, based on a transaction on which consensus is to be reached in the incomplete broadcast batch, the transaction that requires consensus and is proposed in the consensus proposal information; and
reaching consensus on the recovered transaction that requires consensus.

In an implementation, the computer instructions in the computer-readable storage medium 1804 are loaded by the processor 1801 and are further configured for performing the following operations:
searching the transaction pool of the follower node for a corresponding consensus batch based on the consensus batch identifier in the consensus proposal information; and
if a consensus batch corresponding to a target consensus batch identifier in the consensus proposal information is not found in the transaction pool of the follower node, determining that a consensus batch is missing in the transaction pool of the follower node.

The consensus batch corresponding to the target consensus batch identifier is the missing consensus batch.

In an implementation, the computer instructions in the computer-readable storage medium 1804 are loaded by the processor 1801 and are further configured for performing the following operations:
searching the transaction pool of the follower node for a corresponding consensus batch based on the consensus batch identifier in the consensus proposal information;
searching the transaction pool of the follower node for a corresponding broadcast batch based on a broadcast batch identifier in a found consensus batch; and
if a broadcast batch corresponding to a target broadcast batch identifier is not found in the transaction pool of the follower node, determining that a consensus batch is incomplete in the transaction pool of the follower node.

The target broadcast batch identifier is a broadcast batch identifier in the found consensus batch. A consensus batch to which the target broadcast batch identifier belongs is the incomplete consensus batch.

In an implementation, the computer instructions in the computer-readable storage medium 1804 are loaded and executed by the processor 1801, and are further configured for performing the following operations:
receiving a broadcast batch broadcast by the transaction receiving node, the received broadcast batch being generated by the transaction receiving node, when a quantity of received transactions on which consensus is to be reached meets a broadcast batch packaging condition, based on one or more of the received transactions on which consensus is to be reached; and
adding the received broadcast batch to the transaction pool of the follower node.

In an implementation, the computer instructions in the computer-readable storage medium 1804 are loaded by the processor 1801 and are further configured for performing the following operations:
receiving a consensus batch broadcast by the transaction receiving node, the received consensus batch being generated by the transaction receiving node, when a quantity of generated broadcast batches meets a consensus batch packaging condition, based on a broadcast batch identifier of one or more of the generated broadcast batches;
performing broadcast batch query on the transaction pool of the follower node based on the broadcast batch identifier in the received consensus batch;
if a query result indicates that a broadcast batch corresponding to the received consensus batch is lost, obtaining the lost broadcast batch from the transaction receiving node; and
adding the lost broadcast batch to the transaction pool of the follower node.

In an implementation, when loaded and executed by the processor 1801 to obtain the batch structure of the incomplete consensus batch, the computer instructions in the computer-readable storage medium 1804 are specifically configured for performing the following operations:
obtaining the batch structure of the incomplete consensus batch from the transaction pool of the follower node if the batch structure of the incomplete consensus batch exists in the transaction pool of the follower node; or
obtaining the batch structure of the incomplete consensus batch from the leader node if the batch structure of the incomplete consensus batch does not exist in the transaction pool of the follower node.

In the embodiments of the present disclosure, consensus proposal information includes one or more consensus batch identifiers instead of consensus batch content. In this way, more transactions that require consensus can be proposed in the consensus proposal information, thereby improving the consensus efficiency. Moreover, if it is determined, based on the consensus batch identifier in the consensus proposal information, that a consensus batch is incomplete in a transaction pool of a follower node, a batch structure of the incomplete consensus batch may be obtained, it is determined, based on a batch structure of the incomplete consensus batch, that a broadcast batch corresponding to the incomplete consensus batch is incomplete, and the incomplete broadcast batch is obtained from the leader node. In other words, if a consensus batch is incomplete in the transaction pool of the follower node, an incomplete broadcast batch corresponding to the incomplete consensus batch is obtained from the leader node instead of all broadcast batches corresponding to the incomplete consensus batch. In this way, a data volume obtained from the leader node can be reduced, thereby further improving the consensus efficiency.

In some embodiments, the computer device may be a leader node in a blockchain network, and the processor 1801 may load and execute one or more computer instructions stored in the computer-readable storage medium 1804, to implement corresponding operations performed by the leader node in the foregoing method for data processing based on a blockchain network shown in FIG. 10, FIG. 15, or FIG. 16. During specific implementation, the computer instructions in the computer-readable storage medium 1804 are loaded by the processor 1801 to perform the following operations:
creating consensus proposal information, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached;
broadcasting the consensus proposal information to the follower node, to cause the follower node to obtain, if it is determined, based on the consensus batch identifier in the consensus proposal information, that a consensus batch is incomplete in a transaction pool of the follower node, a batch structure of the incomplete consensus batch after receiving the consensus proposal information, and determine, based on the batch structure of the incomplete consensus batch, that a broadcast batch corresponding to the incomplete consensus batch is incomplete; and obtain the incomplete broadcast batch from the leader node, the transaction pool of the follower node being configured to store a broadcast batch and a consensus batch broadcast by the transaction receiving node; and
returning the incomplete broadcast batch to the follower node, to cause the follower node to recover, based on a transaction on which consensus is to be reached in the incomplete broadcast batch, the transaction that requires consensus and is proposed in the consensus proposal information, and reach consensus on the recovered transaction that requires consensus.

In an implementation, when loaded and executed by the processor 1801 to create the consensus proposal information, the computer instructions in the computer-readable storage medium 1804 are specifically configured for performing the following operations:
receiving a broadcast batch broadcast by the transaction receiving node, the received broadcast batch being generated by the transaction receiving node, when a quantity of received transactions on which consensus is to be reached meets a broadcast batch packaging condition, based on one or more of the received transactions on which consensus is to be reached; and
receiving a consensus batch broadcast by the transaction receiving node, the received consensus batch being generated by the transaction receiving node, when a quantity of generated broadcast batches meets a consensus batch packaging condition, based on a broadcast batch identifier of one or more of the generated broadcast batches;
performing an integrity check on the broadcast batch corresponding to the received consensus batch based on the received broadcast batch; and
when a quantity of consensus batches that pass the integrity check meets a consensus proposal condition, creating the consensus proposal information based on a consensus batch identifier of one or more of the consensus batches that pass the integrity check.

In an implementation, the received broadcast batch is added to a transaction pool of the leader node. When loaded and executed by the processor 1801 to perform an integrity check on the broadcast batch corresponding to the received consensus batch based on the received broadcast batch, the computer instructions in the computer-readable storage medium 1804 are specifically configured for performing the following operations:
performing broadcast batch query on the transaction pool of the leader node based on a broadcast batch identifier in the received consensus batch;
if a query result indicates that a broadcast batch corresponding to the received consensus batch is lost, obtaining the lost broadcast batch from the transaction receiving node; and
determining that the received consensus batch passes the integrity check when receiving the lost broadcast batch returned by the transaction receiving node.

In the embodiments of the present disclosure, consensus proposal information includes one or more consensus batch identifiers instead of consensus batch content. In this way, more transactions that require consensus can be proposed in the consensus proposal information, thereby improving the consensus efficiency. Moreover, if it is determined, based on the consensus batch identifier in the consensus proposal information, that a consensus batch is incomplete in a transaction pool of a follower node, a batch structure of the incomplete consensus batch may be obtained, it is determined, based on a batch structure of the incomplete consensus batch, that a broadcast batch corresponding to the incomplete consensus batch is incomplete, and the incomplete broadcast batch is obtained from the leader node. In other words, if a consensus batch is incomplete in the transaction pool of the follower node, an incomplete broadcast batch corresponding to the incomplete consensus batch is obtained from the leader node instead of all broadcast batches corresponding to the incomplete consensus batch. In this way, a data volume obtained from the leader node can be reduced, thereby further improving the consensus efficiency.

In some embodiments, the computer device may be a transaction receiving node in a blockchain network, and the processor 1801 may load and execute one or more computer instructions stored in the computer-readable storage medium 1804, to implement corresponding operations performed by the transaction receiving node in the foregoing method for data processing based on a blockchain network shown in FIG. 6, FIG. 15, or FIG. 16. During specific implementation, the computer instructions in the computer-readable storage medium 1804 are loaded by the processor 1801 to perform the following operations:
receiving a transaction on which consensus is to be reached;
when a quantity of received transactions on which consensus is to be reached meets a broadcast batch packaging condition, generating a broadcast batch based on one or more of the received transactions on which consensus is to be reached, and broadcasting the broadcast batch to the leader node and the follower node;
when a quantity of the generated broadcast batches meets a consensus batch packaging condition, generating a consensus batch based on a broadcast batch identifier of one or more of the generated broadcast batches;
broadcasting the consensus batch to the leader node, to cause the leader node to create consensus proposal information based on the consensus batch, and broadcast the consensus proposal information to the follower node, the consensus proposal information being configured for proposing a transaction that requires consensus; the consensus proposal information including one or more consensus batch identifiers, and each consensus batch identifier being configured to distinctively identify a corresponding consensus batch; a batch structure of a consensus batch including one or more broadcast batch identifiers, and each broadcast batch identifier being configured to distinctively identify a corresponding broadcast batch; and a batch structure of each broadcast batch including one or more transactions on which consensus is to be reached;
broadcasting the consensus batch to the follower node, to cause the follower node to obtain, if it is determined, based on the consensus batch identifier in the consensus proposal information, that a consensus batch is incomplete in a transaction pool of the follower node, a batch structure of the incomplete consensus batch after receiving the consensus proposal information, and determine, based on the batch structure of the incomplete consensus batch, that a broadcast batch corresponding to the incomplete consensus batch is incomplete; obtain the incomplete broadcast batch from the leader node, and recover, based on a transaction on which consensus is to be reached in the incomplete broadcast batch, the transaction that requires consensus and is proposed in the consensus proposal information; and reach consensus on the recovered transaction that requires consensus, the transaction pool of the follower node being configured to store a broadcast batch and a consensus batch broadcast by the transaction receiving node.

In the embodiments of the present disclosure, consensus proposal information includes one or more consensus batch identifiers instead of consensus batch content. In this way, more transactions that require consensus can be proposed in the consensus proposal information, thereby improving the consensus efficiency. Moreover, if it is determined, based on the consensus batch identifier in the consensus proposal information, that a consensus batch is incomplete in a transaction pool of a follower node, a batch structure of the incomplete consensus batch may be obtained, it is determined, based on a batch structure of the incomplete consensus batch, that a broadcast batch corresponding to the incomplete consensus batch is incomplete, and the incomplete broadcast batch is obtained from the leader node. In other words, if a consensus batch is incomplete in the transaction pool of the follower node, an incomplete broadcast batch corresponding to the incomplete consensus batch is obtained from the leader node instead of all broadcast batches corresponding to the incomplete consensus batch. In this way, a data volume obtained from the leader node can be reduced, thereby further improving the consensus efficiency.

According to an aspect of the present disclosure, a computer program product or a computer program is provided. The computer program product or the computer program includes computer instructions, and the computer instructions are stored in a computer-readable storage medium. A processor of the computer device reads the computer instructions from the computer-readable storage medium, and the processor executes the computer instructions, so that the computer device performs the method for data processing based on a blockchain network provided in the foregoing various exemplary manners.

While the foregoing is directed the embodiments of the present disclosure, other and further embodiments the disclosure may be devised without departing from the basic scope thereof, and the scope thereof is determined by the claims that follow.

What is claimed is:

1. A method for data processing based on a blockchain network, the blockchain network comprising a leader node, a follower node, and a transaction receiving node, the method being performed by the follower node, and the method comprising:
receiving consensus proposal information broadcast by the leader node, wherein the consensus proposal information is configured for proposing transactions requiring consensus, and wherein the consensus proposal information comprises one or more consensus batch identifiers associated with one or more consensus batches, a batch structure of each consensus batch comprising one or more broadcast batch identifiers associated with one or more broadcast batches, and a batch structure of each broadcast batch comprising one or more transactions pending consensus;
obtaining a batch structure of an incomplete consensus batch when it is determined, based on the one or more consensus batch identifiers in the consensus proposal information, that one of the one or more consensus batches is incomplete in a transaction pool of the follower node, wherein the transaction pool of the follower node is configured to store a broadcast batch and a consensus batch broadcast by the transaction receiving node;
determining, based on the batch structure of the incomplete consensus batch, that a broadcast batch corresponding to the incomplete consensus batch is incomplete;
obtaining the incomplete broadcast batch from the leader node, and recovering, based on a transaction on which consensus is to be reached in the incomplete broadcast batch, the transaction that requires consensus and is proposed in the consensus proposal information; and
reaching consensus on the recovered transaction that requires consensus.

2. The method according to claim 1, further comprising:
searching the transaction pool of the follower node for a corresponding consensus batch based on the consensus batch identifier in the consensus proposal information; and
when a consensus batch corresponding to a target consensus batch identifier in the consensus proposal information is not found in the transaction pool of the follower node, determining that a consensus batch is missing in the transaction pool of the follower node, the consensus batch corresponding to the target consensus batch identifier being the missing consensus batch.

3. The method according to claim 1, further comprising:
searching the transaction pool of the follower node for a corresponding consensus batch based on the consensus batch identifier in the consensus proposal information;
searching the transaction pool of the follower node for a corresponding broadcast batch based on a broadcast batch identifier in a found consensus batch; and
when a broadcast batch corresponding to a target broadcast batch identifier is not found in the transaction pool of the follower node, determining that a consensus batch is incomplete in the transaction pool of the follower node,
wherein the target broadcast batch identifier comprises a broadcast batch identifier in the found consensus batch; and a consensus batch to which the target broadcast batch identifier belongs comprises the incomplete consensus batch.

4. The method of claim 1, further comprising:
receiving a broadcast batch broadcast by the transaction receiving node, the received broadcast batch being generated by the transaction receiving node, when a quantity of received transactions on which consensus is to be reached meets a broadcast batch packaging condition, based on one or more of the received transactions on which consensus is to be reached; and
adding the received broadcast batch to the transaction pool of the follower node.

5. The method of claim 1, further comprising:
receiving a consensus batch broadcast by the transaction receiving node, the received consensus batch being generated by the transaction receiving node, when a quantity of generated broadcast batches meets a consensus batch packaging condition, based on a broadcast batch identifier of one or more of the generated broadcast batches;
performing broadcast batch query on the transaction pool of the follower node based on the broadcast batch identifier in the received consensus batch;
if a query result indicates that a broadcast batch corresponding to the received consensus batch is lost, obtaining the lost broadcast batch from the transaction receiving node; and
adding the lost broadcast batch to the transaction pool of the follower node.

6. The method of claim 1, obtaining \the batch structure of the incomplete consensus batch comprises:
obtaining the batch structure of the incomplete consensus batch from the transaction pool of the follower node if the batch structure of the incomplete consensus batch exists in the transaction pool of the follower node; or
obtaining the batch structure of the incomplete consensus batch from the leader node if the batch structure of the incomplete consensus batch does not exist in the transaction pool of the follower node.

7. A method for data processing based on a blockchain network, the blockchain network comprising a leader node, a follower node, and a transaction receiving node, the method being performed by the leader node, and the method comprising:
creating consensus proposal information, wherein the consensus proposal information being configured for proposing transactions requiring consensus, and wherein the consensus proposal information comprising one or more consensus batch identifiers associated with one or more consensus batches, a batch structure of each consensus batch comprising one or more broadcast batch identifiers associated with one or more broadcast batches, and a batch structure of each broadcast batch comprising one or more transactions pending consensus;
broadcasting the consensus proposal information to the follower node, to cause the follower node to obtain, when it is determined, based on the consensus batch identifier in the consensus proposal information, that a consensus batch is incomplete in a transaction pool of the follower node, a batch structure of the incomplete consensus batch after receiving the consensus proposal information, and to determine, based on the batch structure of the incomplete consensus batch, that a broadcast batch corresponding to the incomplete consensus batch is incomplete, and obtain the incomplete broadcast batch from the leader node, the transaction pool of the follower node being configured to store a broadcast batch and a consensus batch broadcast by the transaction receiving node; and
returning the incomplete broadcast batch to the follower node, to cause the follower node to recover, based on a transaction on which consensus is to be reached in the incomplete broadcast batch, the transaction that requires consensus and is proposed in the consensus proposal information, and reach consensus on the recovered transaction that requires consensus.

8. The method according to claim 7, wherein creating consensus proposal information comprises:
receiving a broadcast batch broadcast by the transaction receiving node, the received broadcast batch being generated by the transaction receiving node, when a quantity of received transactions on which consensus is to be reached meets a broadcast batch packaging condition, based on one or more of the received transactions on which consensus is to be reached;
receiving a consensus batch broadcast by the transaction receiving node, the received consensus batch being generated by the transaction receiving node, when a quantity of generated broadcast batches meets a consensus batch packaging condition, based on a broadcast batch identifier of one or more of the generated broadcast batches;
performing an integrity check, based on the received broadcast batch, on a broadcast batch corresponding to the received consensus batch; and
when a quantity of consensus batches that pass the integrity check meets a consensus proposal condition, creating the consensus proposal information based on a consensus batch identifier of one or more of the consensus batches that pass the integrity check.

9. The method according to claim 8, wherein the received broadcast batch is added to the transaction pool of the leader node, and performing an integrity check, based on the received broadcast batch, on the broadcast batch corresponding to the received consensus batch comprises:
performing broadcast batch query on the transaction pool of the leader node based on the broadcast batch identifier in the received consensus batch;
when a query result indicates that a broadcast batch corresponding to the received consensus batch is lost, obtaining the lost broadcast batch from the transaction receiving node; and
when receiving the lost broadcast batch returned by the transaction receiving node, determining that the received consensus batch passes the integrity check.

10. A method for data processing based on a blockchain network, the blockchain network comprising a leader node, a follower node, and a transaction receiving node, the method being performed by the transaction receiving node, and the method comprising:
receiving a transaction on which consensus is to be reached;
when a quantity of received transactions on which consensus is to be reached meets a broadcast batch packaging condition, generating a broadcast batch based on one or more of the received transactions on which consensus is to be reached, and broadcasting the broadcast batch to the leader node and the follower node;
when a quantity of generated broadcast batches meets a consensus batch packaging condition, generating a consensus batch based on a broadcast batch identifier of one or more of the generated broadcast batches;
broadcasting the consensus batch to the leader node, to cause the leader node to create consensus proposal information based on the consensus batch, and broadcast the consensus proposal information to the follower node, the consensus proposal information being configured for proposing a transaction that requires consensus, the consensus proposal information comprising one or more consensus batch identifiers, each consensus batch identifier being configured to distinctively identify a corresponding consensus batch, a batch structure of each consensus batch comprising one or more broadcast batch identifiers, each broadcast batch identifier being configured to distinctively identify a corresponding broadcast batch, and a batch structure of each broadcast batch comprising one or more transactions on which consensus is to be reached; and
broadcasting the consensus batch to the follower node, to cause the follower node to obtain, when it is determined, based on the consensus batch identifier in the consensus proposal information, that a consensus batch is incomplete in a transaction pool of the follower node, a batch structure of the incomplete consensus batch after receiving the consensus proposal information, to determine, based on the batch structure of the incomplete consensus batch, that a broadcast batch corresponding to the incomplete consensus batch is incomplete, obtain the incomplete broadcast batch from the leader node, and to recover, based on a transaction on which consensus is to be reached in the incomplete broadcast batch, the transaction that requires consensus and is proposed in the consensus proposal information; and reach consensus on the recovered transaction that requires consensus, the transaction pool of the follower node being configured to store a broadcast batch and a consensus batch broadcast by the transaction receiving node.

11. An apparatus for data processing based on a blockchain network, the blockchain network comprising a leader node, a follower node, and a transaction receiving node, the apparatus being disposed in the follower node, and the apparatus comprising:
a communication unit and
a processing unit, configured to execute the method of claim 1.

12. An apparatus for data processing based on a blockchain network, the blockchain network comprising a leader node, a follower node, and a transaction receiving node, the apparatus being disposed in the leader node, and the apparatus comprising:
a processing unit and
a communication unit, configured to execute the method of claim 7.

13. An apparatus for data processing based on a blockchain network, the blockchain network comprising a leader node, a follower node, and a transaction receiving node, the apparatus being disposed in the transaction receiving node, and the apparatus comprising:
a communication unit and
a processing unit, configured to execute the method of claim 10.

14. A computer device, comprising:
a processor, configured to implement a computer program; and
a computer-readable storage medium, having the computer program stored therein, and the computer program being configured to be loaded by the processor to perform the method for data processing based on a blockchain network according to claim 1.

15. A non-transitory computer-readable storage medium, having a computer program stored therein, and the computer program being configured to be loaded by a processor to perform the method for data processing based on a blockchain network according to claim 7.
